(19) United States
(12) Patent Application Publication
(10) Pub. No.: US 2026/0291332 A1
(43) Pub. Date: Sep. 24, 2026

(54) MOTOR UNIT AND ELECTRIC WORKING MACHINE

(71) Applicant: MAKITA CORPORATION, Anjo-shi (JP)

(72) Inventors: Takaaki KATO, Anjo-shi (JP); Takayoshi IIO, Anjo-shi (JP)

(73) Assignee: MAKITA CORPORATION, Anjo-shi (JP)

(21) Appl. No.: 19/573,106

(22) Filed: Mar. 20, 2026

(30) Foreign Application Priority Data
Mar. 24, 2025 (JP) 2025-049035

(51) Int. Cl. H02K 7/14; H02K 5/22

(52) U.S. Cl. CPC H02K 7/14; H02K 5/22

(57) ABSTRACT

A motor unit may be configured to be detachably attached to a working unit to drive the working unit. The motor unit may include: a motor unit body including an electric motor and a housing that supports the electric motor; and a rotation output assembly exposed to outside of the motor unit body and configured to rotate to output power of the electric motor to the working unit. When the working unit is in a default usage orientation, the motor unit attached to the working unit may be in an upward orientation in which a direction from the motor unit toward the working unit along a rotation axis of the rotation output assembly is vertically upward.

### CROSS REFERENCE TO RELATED APPLICATION

This application claims priority to Japanese Patent Application No. 2025-049035 filed on Mar. 24, 2025. The entire content of the priority application is incorporated herein by reference.

### TECHNICAL FIELD

The art disclosed herein relates to a motor unit and an electric working machine.

### BACKGROUND ART

International Publication No. WO 2020/049617 describes a motor unit configured to be detachably attached to a working unit to drive the working unit. The motor unit includes a motor unit body including an electric motor and a housing that supports the electric motor; and a rotation output assembly exposed to outside of the motor unit body and configured to rotate to output power of the electric motor to the working unit. When the working unit is in a default usage orientation, the motor unit attached to the working unit is in a downward orientation in which a direction from the motor unit toward the working unit along a rotation axis of the rotation output assembly is vertically downward or in a lateral orientation in which the direction from the motor unit toward the working unit along the rotation axis of the rotation output assembly is horizontal.

### SUMMARY

Conventional motor units have restrictions on their attachment orientations to a working unit in its default usage orientation. Therefore, the conventional motor units sometimes may be attached to a specific working unit only in an orientation that is inconvenient for the user (e.g., in a user-inaccessible orientation). The disclosure herein provides a technology that enables a motor unit to be attached to a working unit in a user-friendly orientation.

A motor unit disclosed herein may be configured to be detachably attached to a working unit to drive the working unit. The motor unit may comprise: a motor unit body including an electric motor and a housing that supports the electric motor; and a rotation output assembly exposed to outside of the motor unit body and configured to rotate to output power of the electric motor to the working unit. When the working unit is in a default usage orientation, the motor unit attached to the working unit may be in an upward orientation in which a direction from the motor unit toward the working unit along a rotation axis of the rotation output assembly is vertically upward.

Another motor unit disclosed herein may be configured to be detachably attached to a working unit to drive the working unit. The motor unit may comprise: a motor unit body including an electric motor and a housing that supports the electric motor; and a rotation output assembly exposed to outside of the motor unit body and configured to rotate to output power of the electric motor to the working unit. The motor unit may be configured to be attached to the working unit in a default usage orientation, regardless of a direction from the motor unit toward the working unit along a rotation axis of the rotation output assembly.

An electric working machine disclosed herein may comprise: a working unit; and a motor unit configured to be detachably attached to the working unit to drive the working unit. The motor unit may comprise: a motor unit body including an electric motor and a housing that supports the electric motor; and a rotation output assembly exposed to outside of the motor unit body and configured to rotate to output power of the electric motor to the working unit. When the working unit is in a default usage orientation, the motor unit attached to the working unit may be in an upward orientation in which a direction from the motor unit toward the working unit along a rotation axis of the rotation output assembly is vertically upward.

### BRIEF DESCRIPTION OF DRAWINGS

FIG. 1 is a perspective view of a portable grass cutter 500a with a motor unit 2 according to an embodiment attached thereto, as viewed from the upper front left side.

FIG. 2 is a perspective view of a plate compactor 500b with the motor unit 2 according to the embodiment attached thereto, as viewed from the upper front left side.

FIG. 3 is a perspective view of a pressure washer 500c with the motor unit 2 according to the embodiment attached thereto, as viewed from the upper front left side.

FIG. 4 is a perspective view of the motor unit 2 according to the embodiment as viewed from the upper front right side.

FIG. 5 is a perspective view of the motor unit 2 according to the embodiment as viewed from the upper front right side, where a battery cover 14 is at an open position.

FIG. 6 is a cross-sectional view illustrating a structure surrounding a hook 18 of the motor unit 2 according to the embodiment.

FIG. 7 is a cross-sectional view illustrating the structure surrounding the hook 18 of the motor unit 2 according to the embodiment.

FIG. 8 is an exploded view of an outer housing 12 of the motor unit 2 according to the embodiment.

FIG. 9 is a perspective view of the motor unit 2 according to the embodiment as viewed from the lower rear left side.

FIG. 10 is a perspective view of a battery pack BP according to an embodiment as viewed from the lower rear right side.

FIG. 11 is a perspective view of a power adapter 94 according to an embodiment as viewed from the lower rear left side.

FIG. 12 is a perspective view of a battery receptacle 16 of the motor unit 2 according to the embodiment as viewed from the upper rear right side.

FIG. 13 is a diagram illustrating how the power adapter 94 is attached to the battery receptacle 16 of the motor unit 2 according to the embodiment.

FIG. 14 is a perspective view of a first sealing member 122 of the motor unit 2 according to the embodiment as viewed from the upper rear left side.

FIG. 15 is a cross-sectional view illustrating the internal structure of the motor unit 2 according to the embodiment.

FIG. 16 is an exploded view illustrating a motor housing 138, a control unit 140, and a controller cover 142 of the motor unit 2 according to the embodiment.

FIG. 17 is an exploded view illustrating a rotation output assembly 6, an electric motor 134, a motor housing 138, and a mount base 144 of the motor unit 2 according to the embodiment.

FIG. 18 is an exploded view of a first rotation output assembly 192 of the motor unit 2 according to the embodiment.

FIG. 19 is an exploded view of a second rotation output assembly 194 of the motor unit 2 according to the embodiment.

FIG. 20 is an exploded view of a third rotation output assembly 196 of the motor unit 2 according to the embodiment.

FIG. 21 is a cross-sectional view illustrating a shaft lock mechanism 214 of the motor unit 2 according to the embodiment.

FIG. 22 is an exploded view of a first cover assembly 254 of the motor unit 2 according to the embodiment.

FIG. 23 is an exploded view of a second cover assembly 268 of the motor unit 2 according to the embodiment.

FIG. 24 is an exploded view of a first input assembly 298 of the motor unit 2 according to the embodiment.

FIG. 25 is an exploded view of a second input assembly 312 of the motor unit 2 according to the embodiment.

FIG. 26 is a diagram illustrating the structure of a second support plate 314 of the second input assembly 312 of the motor unit 2 according to the embodiment.

FIG. 27 is an exploded view illustrating a connection between a wire 322 of the second input assembly 312 and a push member 324 of the motor unit 2 according to the embodiment.

FIG. 28 is an exploded view of a third input assembly 350 of the motor unit 2 according to the embodiment.

FIG. 29 is a bottom view of the motor unit 2 according to the embodiment.

FIG. 30 is a perspective view of a connector 528 attached to the motor unit 2 according to the embodiment as viewed from the lower rear left side.

FIG. 31 is a perspective view of a bottom cover 370 attached to the motor unit 2 according to the embodiment as viewed from the lower rear left side.

FIG. 32 is a diagram illustrating how the motor unit 2 according to the embodiment is attached to a working unit 500.

FIG. 33 is a diagram schematically illustrating the shaft lock mechanism 214 of the motor unit 2 according to the embodiment.

### DETAILED DESCRIPTION

In one aspect of the present teachings, a motor unit may be configured to be detachably attached to a working unit to drive the working unit. The motor unit may comprise: a motor unit body including an electric motor and a housing that supports the electric motor; and a rotation output assembly exposed to outside of the motor unit body and configured to rotate to output power of the electric motor to the working unit. When the working unit is in a default usage orientation, the motor unit attached to the working unit may be in an upward orientation in which a direction from the motor unit toward the working unit along a rotation axis of the rotation output assembly is vertically upward.

There have not been any conventional motor units that can be attached in the upward orientation to a working unit in its default usage orientation. However, the configuration above allows the motor unit to be attached in the upward orientation to the working unit in the default usage orientation. Thus, the configuration above allows a user to attach the motor unit to a working unit located above the user’s head from vertically below, i.e., to a position easily accessible by the user. Therefore, the configuration above allows the motor unit to be attached in a user-friendly orientation to the working unit.

In one aspect of the present teachings, the motor unit may further comprise a battery receptacle disposed on the housing and to which a battery pack is detachably attached. The battery pack may be configured to be attached to the battery receptacle by being slid in a predetermined first direction relative to the battery receptacle. When the motor unit is in the upward orientation, the first direction may be along a horizontal plane.

If the working unit is located in the sliding direction of the battery pack, the battery pack (or the user’s hand on the battery pack) may contact the working unit when it is slid in the sliding direction. This may make the attachment/detachment of the battery pack to/from the battery receptacle cumbersome. When the motor unit is in the upward orientation, the working unit is expected to be located vertically above the motor unit. According to the configuration above, the direction in which the battery pack is slid relative to the battery receptacle is along the horizontal plane (i.e., a direction in which the working unit is not expected to be located). Therefore, the battery pack (or the user’s hand on the battery pack) is prevented from contacting the working unit when the battery pack is slid. Thus, the cumbersome nature of attachment/detachment of the battery pack to/from the battery receptacle can be reduced.

In one aspect of the present teachings, the motor unit may further comprise a battery cover pivotably attached to the housing between a closing position in which the battery cover covers the battery pack attached to the battery receptacle and an open position in which the battery cover does not cover the battery pack attached to the battery receptacle. When the motor unit is in the upward orientation, the battery cover may move between the closing position and the open position along the horizontal plane.

If the working unit is located in the opening/closing direction of the battery cover, the battery cover (or the user’s hand on the battery cover) may contact the working unit when the battery cover is opened/closed. This may make the opening/closing of the battery cover cumbersome. When the motor unit is in the upward orientation, the working unit is expected to be located vertically above the motor unit. According to the configuration above, the opening/closing direction of the battery cover is along the horizontal plane (i.e., a direction in which the working unit is not expected to be located). Therefore, the battery cover (or the user’s hand on the battery cover) is prevented from contacting the working unit when the battery cover is opened/closed. Thus, the cumbersome nature of opening/closing of the battery cover can be reduced.

In one aspect of the present teachings, when the motor unit is in the upward orientation, a longitudinal direction of the motor unit body may be along a horizontal plane.

The motor unit in the upward orientation may be attached to the working unit from vertically below. In this case, if the vertical dimension of the motor unit body is large, the motor unit may contact an object located vertically below the working unit (e.g., the user’s body, the ground, etc.). With the configuration above, when the motor unit in the upward orientation is attached to the working unit from vertically below, the vertical dimension of the motor unit body is relatively small. Therefore, the motor unit is prevented from contacting an object located vertically below the working unit.

In one aspect of the present teachings, when the motor unit is in the upward orientation, a vertical dimension of the motor unit body may be 200 mm or less.

The motor unit in the upward orientation may be attached to the working unit from vertically below. In this case, if the vertical dimension of the motor unit body is large, the motor unit may contact an object located vertically below the working unit (e.g., the user’s body, the ground, etc.). With the configuration above, when the motor unit in the upward orientation is attached to the working unit from vertically below, the vertical dimension of the motor unit body is relatively small. Therefore, the motor unit is prevented from contacting an object located vertically below the working unit.

In one aspect of the present teachings, the motor unit may further comprise a power button for turning on and off a main power of the motor unit. When the motor unit is in the upward orientation, the power button may be disposed on a surface of the motor unit that is oriented vertically downward.

With the configuration above, when the motor unit is attached in the upward orientation to the working unit from vertically below, the power button is located on a surface of the motor unit that is away from the working unit, i.e., a surface of the motor unit that is easily accessible by the user. This further improves user-friendliness of the motor unit.

In one aspect of the present teachings, the motor unit body may comprise: a neck portion extending vertically downward from the working unit when the motor unit is in the upward orientation; and a head portion connected to a vertically lower end of the neck portion, wherein a dimension of the head portion in a horizontal direction is larger than that of the neck portion.

With the configuration above, the user can hold the motor unit body by grabbing the head portion. Further, with the configuration above, when the motor unit is attached to the working unit, the neck portion is located between the head portion and the working unit, thus the head portion is located apart from the working unit. This prevents the user’s hand on the head portion from contacting the working unit, thereby freeing the user from cumbersome work.

In one aspect of the present teachings, the motor unit may further comprise a ventilation opening that provides communication between an inside and an outside of the housing. The ventilation opening is formed in the neck portion.

Generally, the neck portion is expected to be less accessible by the user than the head portion. According to the configuration above, the ventilation opening is formed in the portion less accessible by the user. Therefore, air intake and/or air discharge through the ventilation opening is not hindered by the user.

In one aspect of the present teachings, another motor unit may be configured to be detachably attached to a working unit to drive the working unit. The motor unit may comprise: a motor unit body including an electric motor and a housing that supports the electric motor; and a rotation output assembly exposed to outside of the motor unit body and configured to rotate to output power of the electric motor to the working unit. The motor unit may be configured to be attached to the working unit in a default usage orientation, regardless of a direction from the motor unit toward the working unit along a rotation axis of the rotation output assembly.

With the configuration above, there are no restrictions on the orientation of the motor unit when it is attached to the working unit in the default usage orientation. Therefore, the configuration above allows the motor unit to be attached in a user-friendly orientation (e.g., in a user-accessible orientation) to the working unit.

In one aspect of the present teachings, an electric working machine may comprise: a working unit; and a motor unit configured to be detachably attached to the working unit to drive the working unit. The motor unit may comprise: a motor unit body including an electric motor and a housing that supports the electric motor; and a rotation output assembly exposed to outside of the motor unit body and configured to rotate to output power of the electric motor to the working unit. When the working unit is in a default usage orientation, the motor unit attached to the working unit may be in an upward orientation in which a direction from the motor unit toward the working unit along a rotation axis of the rotation output assembly is vertically upward.

There have not been any conventional motor units that can be attached in the upward orientation to a working unit in its default usage orientation. However, the configuration above allows the motor unit to be attached in the upward orientation to the working unit in the default usage orientation. Thus, the configuration above allows a user to attach the motor unit to the working unit located above the user’s head from vertically below, i.e., to a position easily accessible by the user. Therefore, the configuration above allows the motor unit to be attached in a user-friendly orientation to the working unit.

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the disclosure. Furthermore, each of the additional features and teachings disclosed below may be utilized separately or in conjunction with other features and teachings to provide improved motor units and electric working machines.

Moreover, combinations of features and steps disclosed in the following detailed description may not be necessary to practice the disclosure in the broadest sense, and are instead taught merely to particularly describe representative examples of the disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### Embodiment

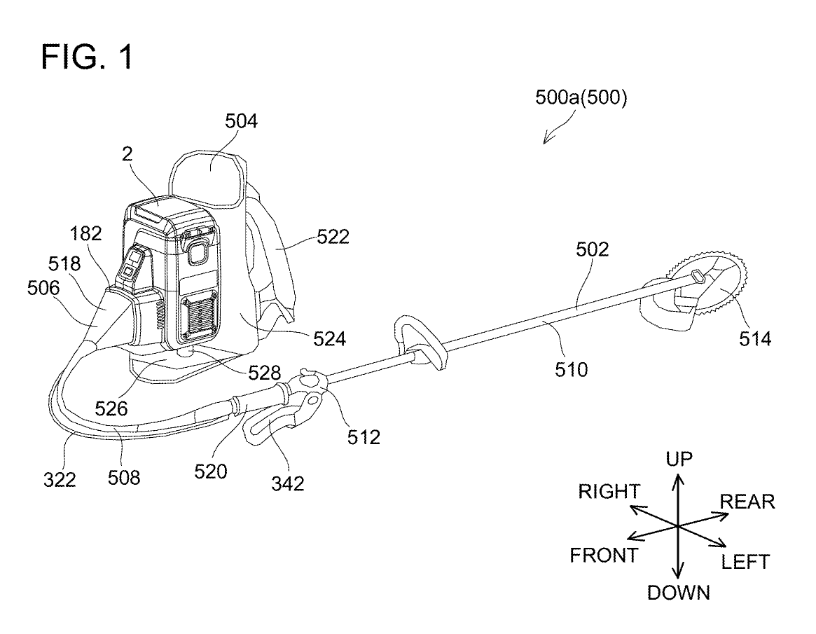

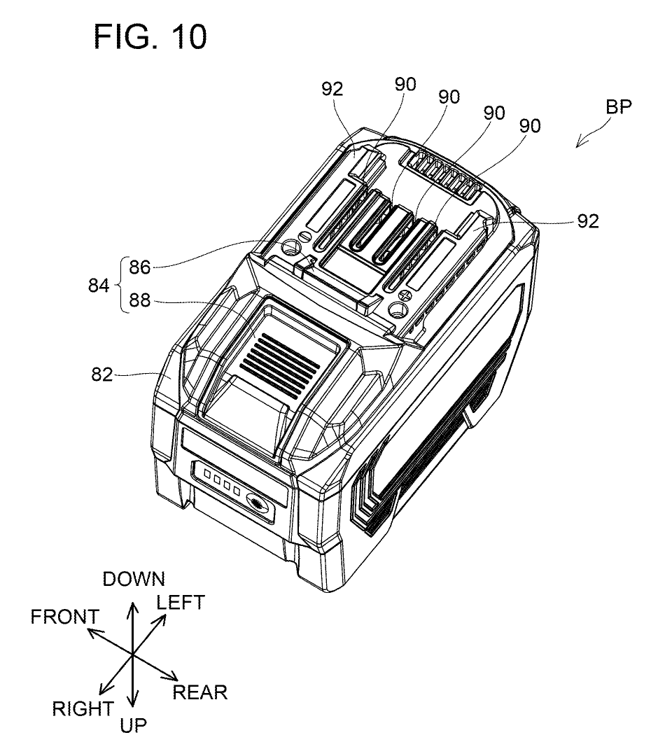

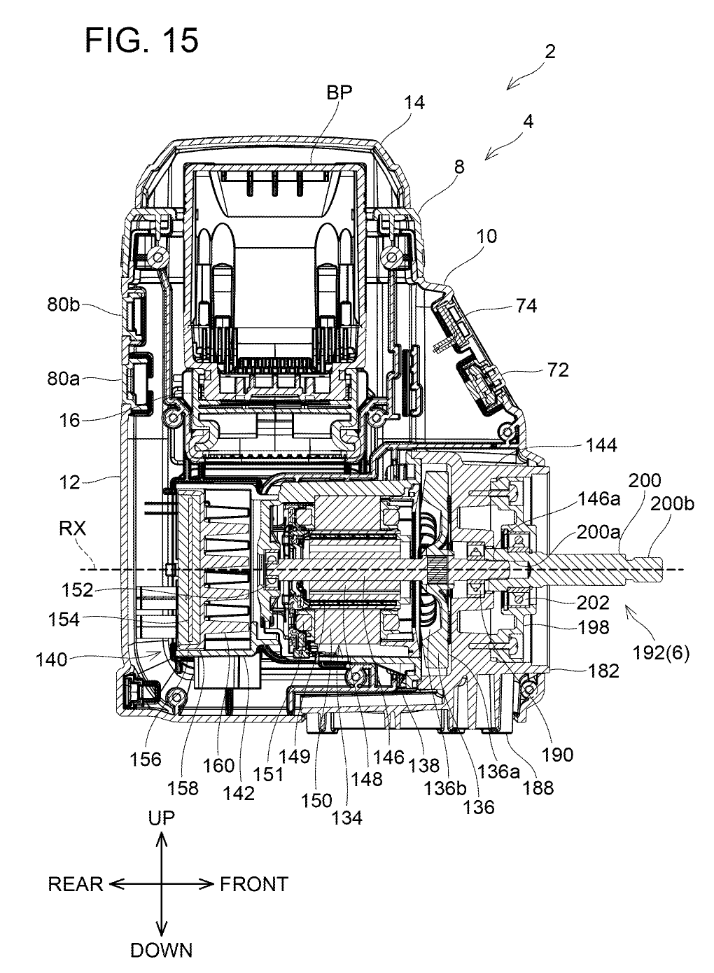

As illustrated in FIGS. 1, 2, and 3, a motor unit 2 can be selectively attached to multiple types of working units 500. The motor unit 2 is an electric device configured to generate driving power by driving an electric motor 134 (see FIG. 15) using electric power supplied from a power supply such as a battery pack BP (see FIG. 10). The working units 500 perform operations using the driving power generated by the motor unit 2. Instead of the motor unit 2, a universal engine unit can be attached to the working units 500. The universal engine unit is, for example, GX35 available from Honda R&D Co., Ltd. That is, one of the motor unit 2 and the engine unit can be selectively applied to each working unit 500.

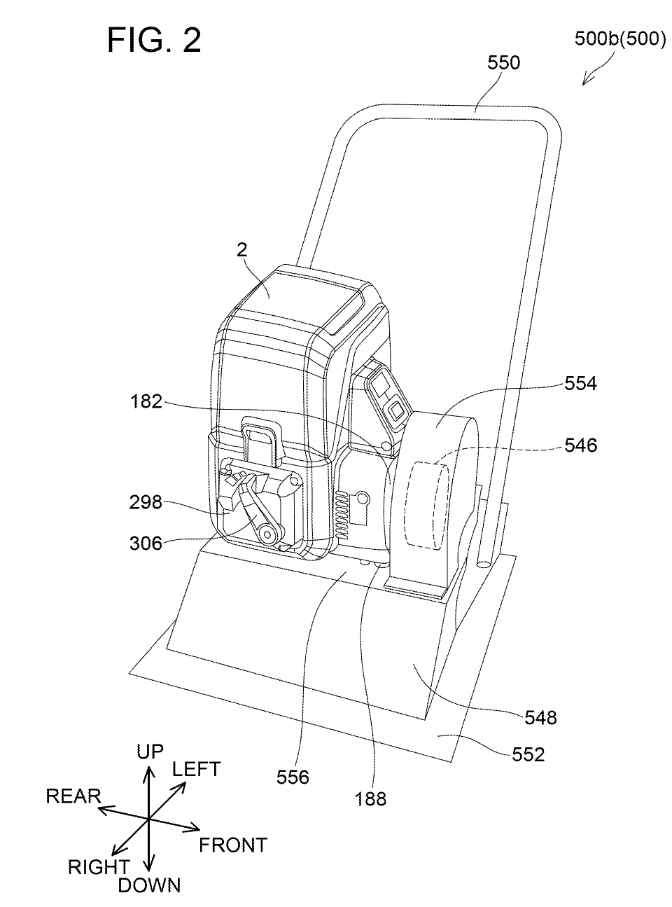

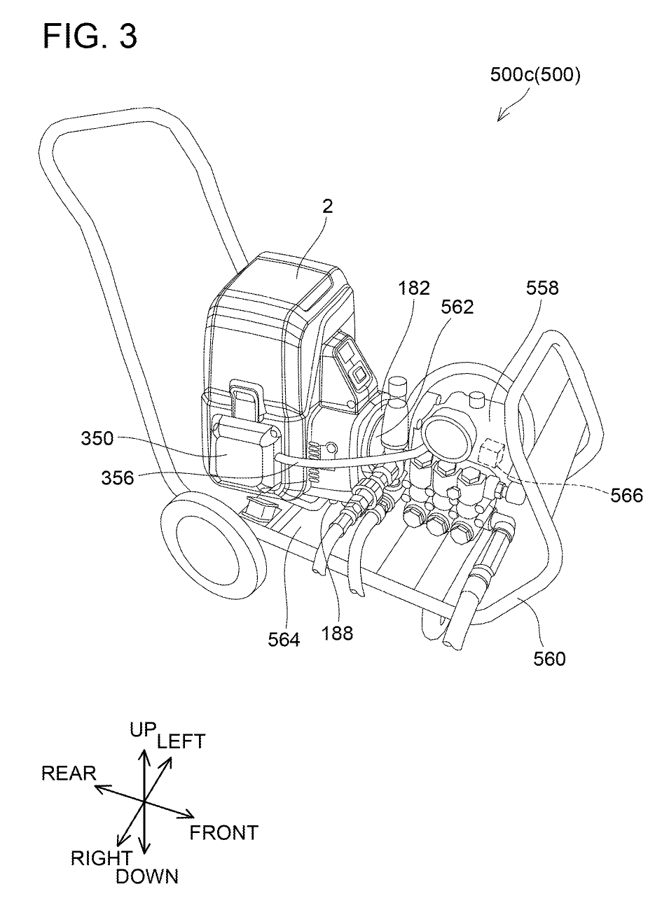

The working unit 500 illustrated in FIG. 1 is a portable grass cutter 500a. The working unit 500 illustrated in FIG. 2 is a plate compactor 500b. The working unit 500 illustrated in FIG. 3 is a pressure washer 500c. The working units 500 are not limited to these and may include, for example, a winch, a screed, a trowel, a rammer, a push-type lawn mower, an edger, a sprayer, a concrete mixer, a concrete saw, and a compaction roller. The motor unit 2 is attached to a working unit 500 to drive the working unit 500. In the disclosure herein, an assembly where the motor unit 2 is attached to a working unit 500 is also referred to as an electric working machine.

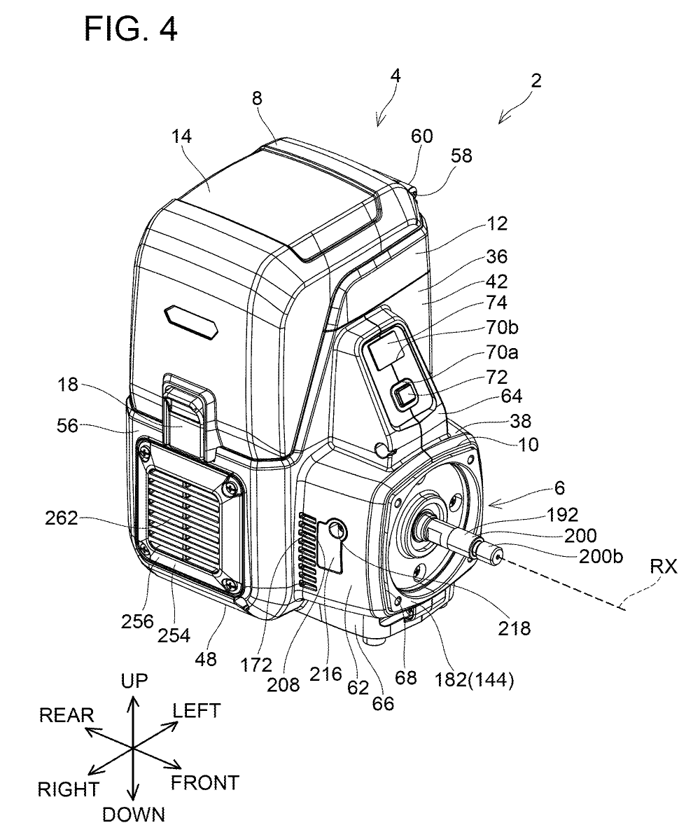

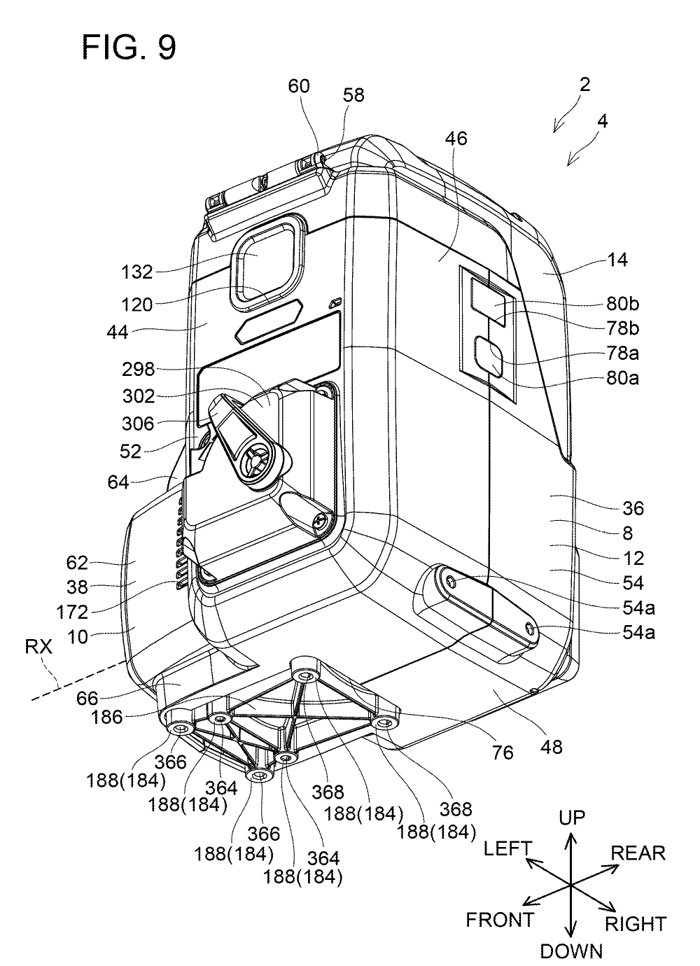

As illustrated in FIG. 4, the motor unit 2 comprises a motor unit body 4 and a rotation output assembly 6. The motor unit body 4 comprises a head portion 8 having a substantially rectangular parallelepiped shape and a neck portion 10 projecting forward from the front surface of the head portion 8. The rotation output assembly 6 is exposed to a space in front of the neck portion 10. The rotation output assembly 6 is connected to the electric motor 134 (see FIG. 15) housed in the motor unit body 4 and outputs the driving power of the electric motor 134 to a working unit 500 (see FIGS. 1, 2, 3). The rotation output assembly 6 comprises a rotation element that rotates about a rotation axis RX (which is a first spindle 200 in the example illustrated in FIG. 4). In the present embodiment, a direction that is along the rotation axis RX of the rotation output assembly 6 and in which the rotation output assembly 6 is oriented is termed a front direction (or forward), and the opposite direction to the front direction is termed a rear direction (or rearward). Further, a direction that is orthogonal to the front-rear direction and in which lower attachment surfaces 188 (see FIG. 9) are oriented is termed a down direction (or downward), and the opposite direction to the down direction is termed an up direction (or upward). Moreover, a direction that is orthogonal to the front-rear direction and the up-down direction and in which a hook 18 of a battery cover 14 is oriented is termed a right direction (or rightward), and the opposite direction to the right direction is termed a left direction (leftward).

The dimension of the motor unit body 4 in the front-rear direction is in the range of 180 mm to 200 mm, and it is, for example, 200 mm. The dimension of the motor unit body 4 in the up-down direction is in the range of 275 mm to 295 mm, and it is, for example, 285 mm. The dimension of the motor unit body 4 in the left-right direction is in the range of 185 mm to 205 mm, and it is, for example, 195 mm.

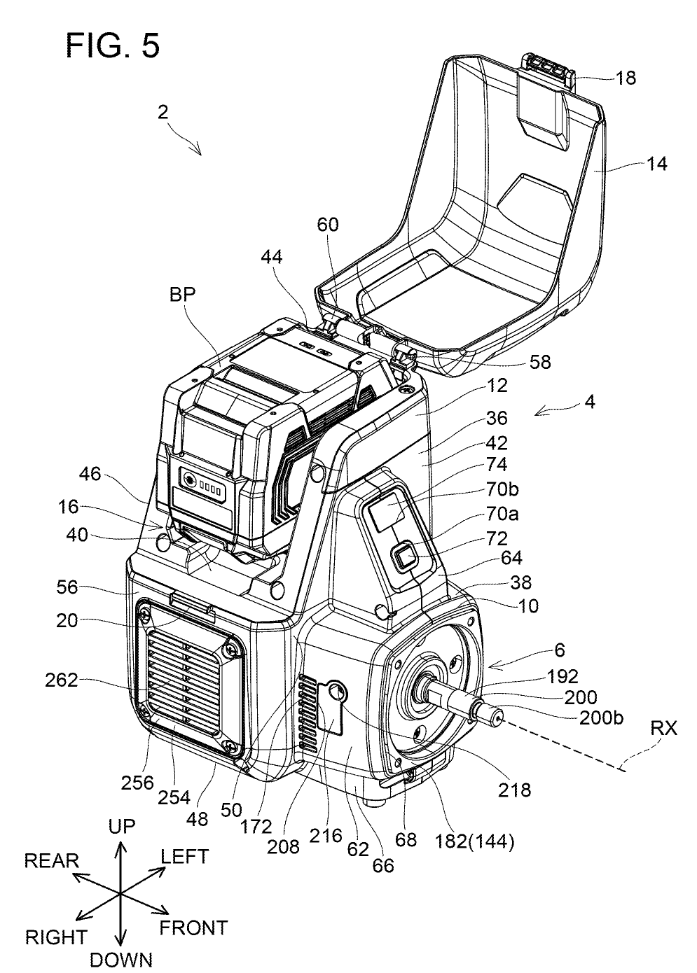

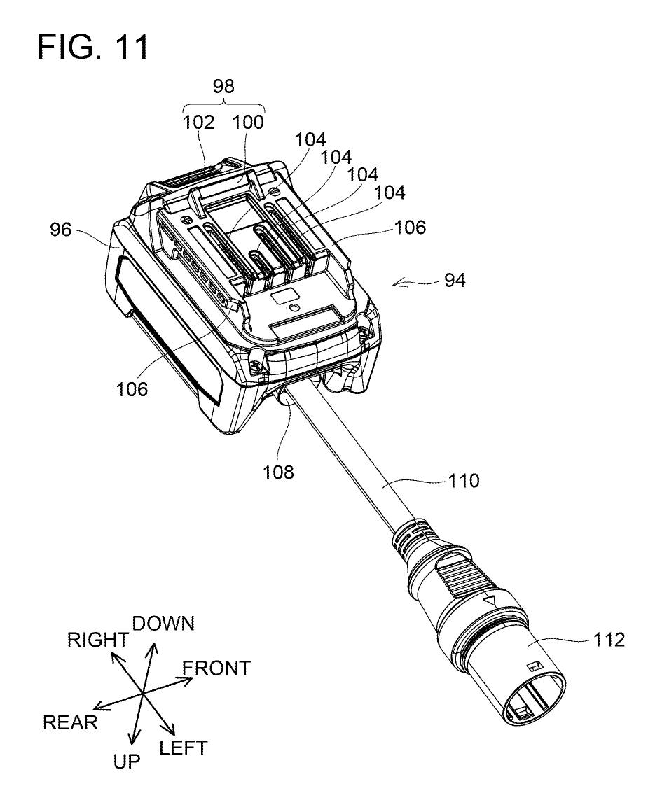

As illustrated in FIGS. 4 and 5, the motor unit body 4 comprises an outer housing 12 and a battery cover 14. A resin material is used for each of the outer housing 12 and the battery cover 14. A battery receptacle 16 is located in the outer housing 12, and the battery pack BP is detachably attached to the battery receptacle 16. Although details are described later, a power adapter 94 (see FIG. 11) can be attached to the battery receptacle 16 instead of the battery pack BP. The battery cover 14 is attached to the outer housing 12 such that it is pivotable between a closing position where the battery cover 14 covers the battery pack BP (or the power adapter 94) attached to the battery receptacle 16 (i.e., the position illustrated in FIG. 4) and an open position where the battery cover 14 does not cover the battery pack BP (or the power adapter 94) attached to the battery receptacle 16 (i.e., the position illustrated in FIG. 5). A hook 18 for retaining the battery cover 14 at the closing position is attached to the battery cover 14.

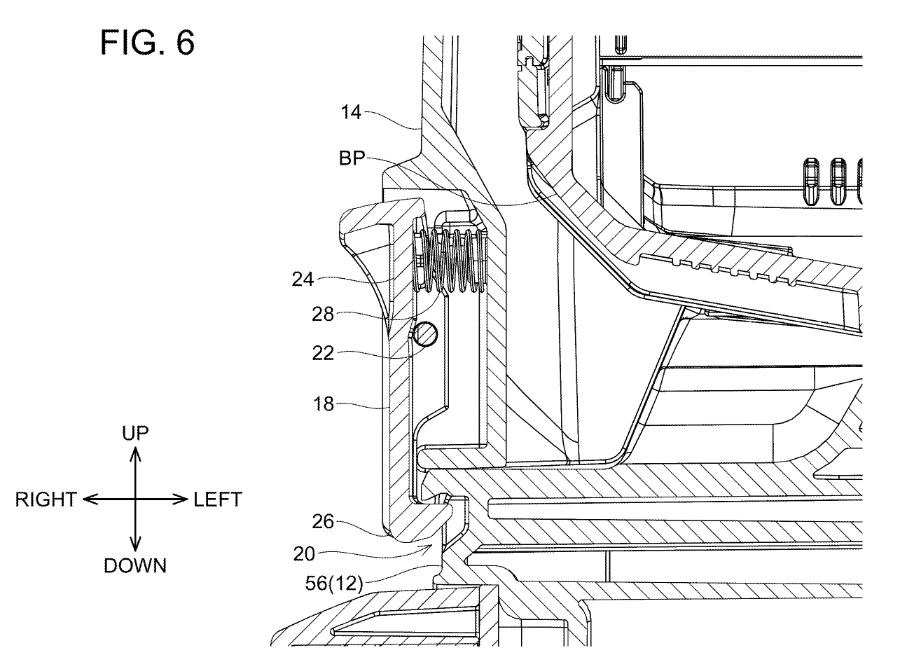

As illustrated in FIG. 6, the hook 18 engages a recess 20 formed in the outer housing 12. Further, the hook 18 is pivotably attached to the battery cover 14 via a pin 22 extending in the front-rear direction. The hook 18 comprises an operation portion 24 located above the pin 22 and a claw portion 26 located below the pin 22. The operation portion 24 is biased rightward by a coil spring 28 against the battery cover 14. That is, the claw portion 26 is biased leftward (i.e., in a direction toward the recess 20). In the state illustrated in FIG. 6, the battery cover 14 cannot be opened because the claw portion 26 interferes with the upper wall of the recess 20.

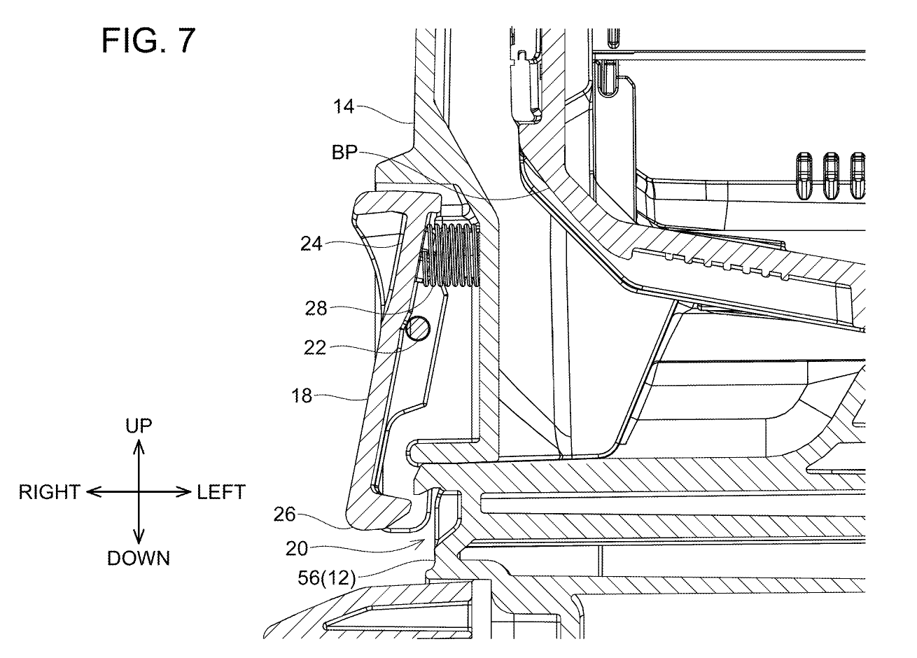

When the operation portion 24 is pushed leftward against the biasing force of the coil spring 28 as illustrated in FIG. 7, the claw portion 26 comes out from the recess 20. That is, the hook 18 is disengaged from the recess 20. In this state, the battery cover 14 can be opened to the open position since the claw portion 26 does not interfere with the recess 20. To engage the hook 18 with the recess 20 again, a user does not have to push the operation portion 24 and need only to close the battery cover 14. This is because the upper wall of the recess 20 pushes the claw portion 26 rightward against the biasing force of the coil spring 28 as the battery cover 14 is closed. As the battery cover 14 is further closed, the claw portion 26 moves past the upper wall of the recess 20 and is inserted into the recess 20 by the biasing force of the coil spring 28, thereby establishing engagement between the hook 18 and the recess 20.

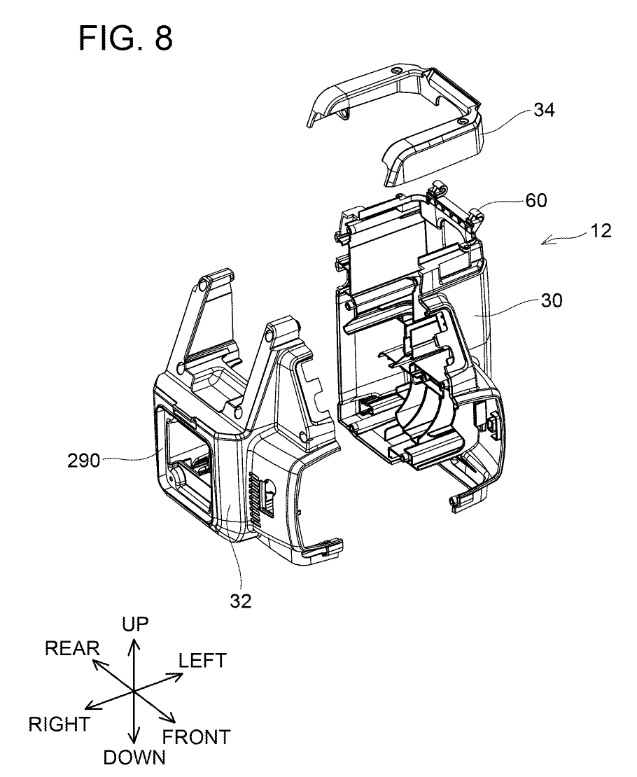

As illustrated in FIG. 8, the outer housing 12 comprises a left member 30, a right member 32, and an upper member 34. The left member 30 defines the outer contour of the left half of the outer housing 12. The right member 32 defines the outer contour of the right half of the outer housing 12. The upper member 34 is located on the upper end of the left member 30. The upper member 34 has a trademark owned by the manufacturer of the motor unit 2 thereon, although this is not illustrated. Here, business operators that sell electric working machines where the motor unit 2 is attached to working units 500 (see FIGS. 1, 2, 3) (i.e., sellers of electric working machines) are not necessarily the same as the manufacturer of the motor unit 2. A seller of electric working machines may wish to replace the trademark on the motor unit 2 with its own trademark. In this case, the seller of electric working machines can manufacture an upper member 34 marked with its own trademark and replace the existing upper member 34 of the motor unit 2 with their own upper member 34. Thus, the sellers of electric working machines can easily replace the trademark on the motor unit 2 with their own trademarks.

As illustrated in FIG. 4, the outer housing 12 comprises a first portion 36 forming the head portion 8 of the motor unit body 4 together with the battery cover 14 and a second portion 38 forming the neck portion 10 of the motor unit body 4.

As illustrated in FIGS. 5 and 9, the first portion 36 of the outer housing 12 comprises an upper bottom wall 40, an upper front wall 42, an upper left wall 44, an upper rear wall 46, a lower bottom wall 48, a lower front wall 50, a lower left wall 52, a lower rear wall 54, and a lower right wall 56. The upper bottom wall 40 is located in a central portion of the motor unit 2 and extends in the front-rear direction and the left-right direction. The battery receptacle 16 is located on the upper bottom wall 40. The upper front wall 42 extends upward from the front end of the upper bottom wall 40 and faces the front surface of the battery pack BP (or the power adapter 94) attached to the battery receptacle 16. The upper left wall 44 extends upward from the left end of the upper bottom wall 40 and faces the left surface of the battery pack BP (or the power adapter 94) attached to the battery receptacle 16. The upper rear wall 46 extends upward from the rear end of the upper bottom wall 40 and faces the rear surface of the battery pack BP (or the power adapter 94) attached to the battery receptacle 16. A cover support 60 is located at the upper end of the upper left wall 44, and the cover support 60 supports the battery cover 14 such that the battery cover 14 is pivotable about a shaft 58 extending in the front-rear direction. The lower bottom wall 48 is located in a lower portion of the motor unit 2, extends in the front-rear direction and the left-right direction, and defines the lower surface of the motor unit 2. The lower front wall 50 extends in the up-down direction between the front end of the lower bottom wall 48 and the front end of the upper bottom wall 40. The front surface of the lower front wall 50 is flush with the front surface of the upper front wall 42. The lower left wall 52 extends in the up-down direction between the left end of the lower bottom wall 48 and the left end of the upper bottom wall 40. The left surface of the lower left wall 52 is flush with the left surface of the upper left wall 44. The lower rear wall 54 extends in the up-down direction between the rear end of the lower bottom wall 48 and the rear end of the upper bottom wall 40. The rear surface of the lower rear wall 54 is flush with the rear surface of the upper rear wall 46. The lower right wall 56 extends in the up-down direction between the right end of the lower bottom wall 48 and the right end of the upper bottom wall 40.

As illustrated in FIG. 5, the second portion 38 of the outer housing 12 comprises a projecting portion 62, a pedestal portion 64, and a bottom portion 66. The projecting portion 62 projects forward from the front surface of the first portion 36. A front exposure opening 68 is formed in the front end of the projecting portion 62, and a front attachment surface 182 of a mount base 144 (see FIG. 15) is exposed through the front exposure opening 68. The pedestal portion 64 extends between the front surface of the first portion 36 and the upper surface of the projecting portion 62. Front arrangement openings 70a, 70b are formed in the front surface of the pedestal portion 64, and a button, a display, etc. are arranged in the front arrangement openings 70a,70b. In the present embodiment, a power button 72 for turning on/off the main power of the motor unit 2 is arranged in the front arrangement opening 70a, and a display 74 for displaying various aspects of the motor unit 2 (e.g., whether the main power of the motor unit 2 is on or off, remaining charge in the battery pack BP, etc.) is arranged in the front arrangement opening 70b.

As illustrated in FIG. 9, the bottom portion 66 projects downward from the lower surface of the projecting portion 62. The lower surface of the bottom portion 66 is flush with the lower surface of the first portion 36 (specifically, the lower surface of the lower bottom wall 48). A lower exposure opening 76 is formed traversing across the bottom portion 66 and the lower bottom wall 48, and lower attachment surfaces 188 of the mount base 144 (see FIG. 15) are exposed through the lower exposure opening 76. Further, rear arrangement openings 78a, 78b are formed in the rear surface of the first portion 36 (specifically, the rear surface of the upper rear wall 46). The shapes of the rear arrangement openings 78a, 78b are the same as the shapes of the front arrangement openings 70a, 70b (see FIG. 4), respectively. Thus, a button, a display, etc. can be also arranged in the rear arrangement openings 78a, 78b. In the present embodiment, a button, a display, etc. are not arranged in the rear arrangement openings 78a, 78b, and closure plates 80a, 80b are arranged in the rear arrangement openings 78a, 78b to close them. The closure plate 80a may be replaced with the power button 72 (see FIG. 4), and/or the closure plate 80b may be replaced with the display 74 (see FIG. 4).

As illustrated in FIG. 10, the battery pack BP comprises a battery housing 82 for housing a plurality of rechargeable secondary battery cells (e.g., lithium-ion battery cells) and a hook 84 movably held by the battery housing 82. The hook 84 comprises an engagement portion 86 and an operation portion 88. The engagement portion 86 usually projects to the outside of the battery housing 82. When the operation portion 88 is pushed into the battery housing 82, the engagement portion 86 is entirely moved into the battery housing 82. Slits 90 and guide rails 92 are formed in the battery housing 82. The slits 90 provide communication between the inside of the battery housing 82 and the outside of the battery housing 82. The slits 90 are positioned corresponding to the positions of battery terminals (not illustrated) housed in the battery housing 82. The plurality of secondary battery cells is charged and discharged through the battery terminals. The front-rear direction, up-down direction, and left-right direction in FIG. 10 correspond to the front-rear direction, up-down direction, and left-right direction of the battery pack BP attached to the battery receptacle 16 (see FIG. 5).

As illustrated in FIG. 11, the power adapter 94 comprises an adapter housing 96 and a hook 98 movably held by the adapter housing 96. The hook 98 comprises an engagement portion 100 and an operation portion 102. The engagement portion 100 usually projects to the outside of the adapter housing 96. When the operation portion 102 is pushed into the adapter housing 96, the engagement portion 100 is entirely moved into the adapter housing 96. Slits 104 and guide rails 106 are formed in the adapter housing 96. The slits 104 provide communication between the inside of the adapter housing 96 and the outside of the adapter housing 96. The power adapter 94 is connected to an end of a power cable 110 via a joint 108. The joint 108 is pivotable relative to the power adapter 94 about its pivot axis extending in the front-rear direction. A power connector 112 for connection to an external power supply (e.g., a power supply device, power generator, commercial power supply) (not illustrated) is located at the opposite end of the power cable 110. Adapter terminals (not illustrated) electrically connected to the power connector 112 via the power cable 110 are housed in the adapter housing 96. The slits 104 are positioned corresponding to the positions of the adapter terminals housed in the adapter housing 96. The external power supply is discharged through the adapter terminals. The power adapter 94 is different from the battery pack BP in that the former does not comprise secondary battery cells and supplies electric power from the external power supply to the motor unit 2. The front-rear direction, up-down direction, and left-right direction in FIG. 11 correspond to the front-rear direction, up-down direction, and left-right direction of the power adapter 94 attached to the battery receptacle 16 (see FIG. 5).

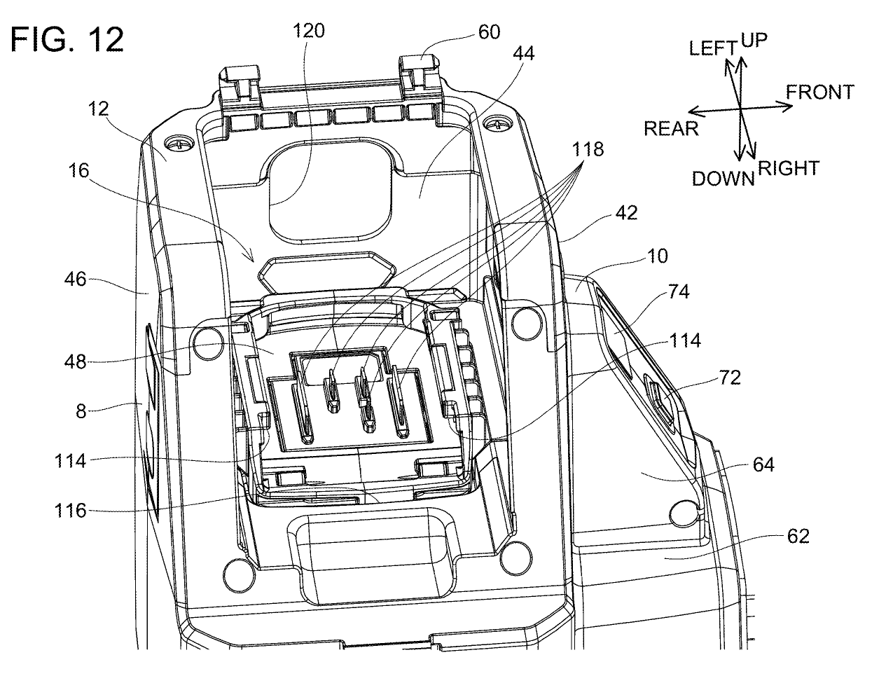

As illustrated in FIG. 12, the battery receptacle 16 comprises guide grooves 114 configured to receive the guide rails 92 of the battery pack BP (or the guide rails 106 of the power adapter 94) (see FIGS. 10, 11) such that the guide rails are slidable in the left-right direction, an engagement groove 116 configured to engage the engagement portion 86 of the battery pack BP (or the engagement portion 100 of the power adapter 94) (see FIG. 10, 11), and connection terminals 118 corresponding to the battery terminals of the battery pack BP (or the adapter terminals of the power adapter 94).

To attach the battery pack BP (see FIG. 10) to the battery receptacle 16, the battery pack BP is slid leftward relative to the battery receptacle 16. As a result, the guide rails 92 (see FIG. 10) are received in the guide grooves 114 and the engagement portion 86 (see FIG. 10) is engaged with the engagement groove 116, thereby completing the attachment of the battery pack BP. When the battery pack BP is in the state of being attached to the battery receptacle 16, the connection terminals 118 are inserted in the battery housing 82 (see FIG. 10) through the slits 90 (see FIG. 10) and engaged with corresponding battery terminals. Thus, the connection terminals 118 are electrically connected to the battery terminals. To detach the battery pack BP from the battery receptacle 16, first the operation portion 88 (see FIG. 10) is pushed to disengage the engagement portion 86 from the engagement groove 116, and then the battery pack BP is slid rightward relative to the battery receptacle 16. As a result, the guide rails 92 come out from the guide grooves 114, thereby completing the detachment of the battery pack BP.

To attach the power adapter 94 (see FIG. 11) to the battery receptacle 16, the power adapter 94 is slid leftward relative to the battery receptacle 16. As a result, the guide rails 106 (see FIG. 11) are received in the guide grooves 114 and the engagement portion 100 (see FIG. 11) is engaged with the engagement groove 116, thereby completing the attachment of the power adapter 94. When the power adapter 94 is in the state of being attached to the battery receptacle 16, the connection terminals 118 are inserted in the adapter housing 96 (see FIG. 11) through the slits 104 (see FIG. 11) and engaged with corresponding adapter terminals. Thus, the connection terminals 118 are electrically connected to the adapter terminals. To detach the power adapter 94 from the battery receptacle 16, first the operation portion 102 (see FIG. 11) is pushed to disengage the engagement portion 100 from the engagement groove 116, and then the power adapter 94 is slid rightward relative to the battery receptacle 16. As a result, the guide rails 106 come out from the guide grooves 114, thereby completing the detachment of the power adapter 94.

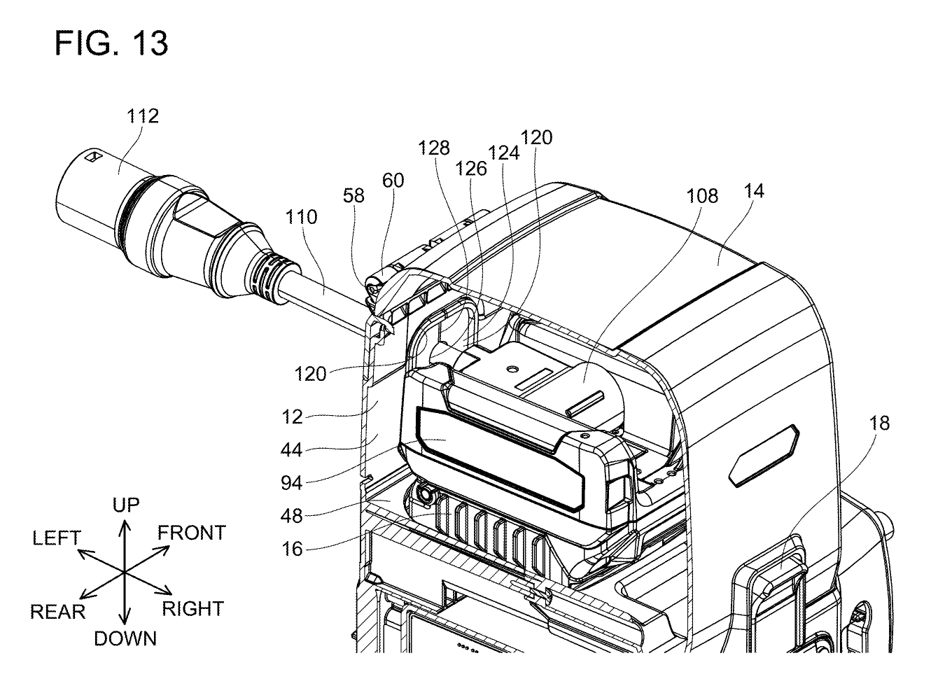

As illustrated in FIG. 13, a through hole 120 is formed in the upper left wall 44 of the outer housing 12, and the through hole 120 is configured to allow each of the power cable 110 and the power connector 112 to pass therethrough. A first sealing member 122 is attached to the through hole 120 to seal the through hole 120 together with the power cable 110. A rubber material is used for the first sealing member 122. The rubber hardness (Hs JIS A) of the rubber material of the first sealing member 122 is in the range of 50 Hs to 90 Hs or in the range of 65 Hs to 75 Hs, and it is, for example, 70 Hs.

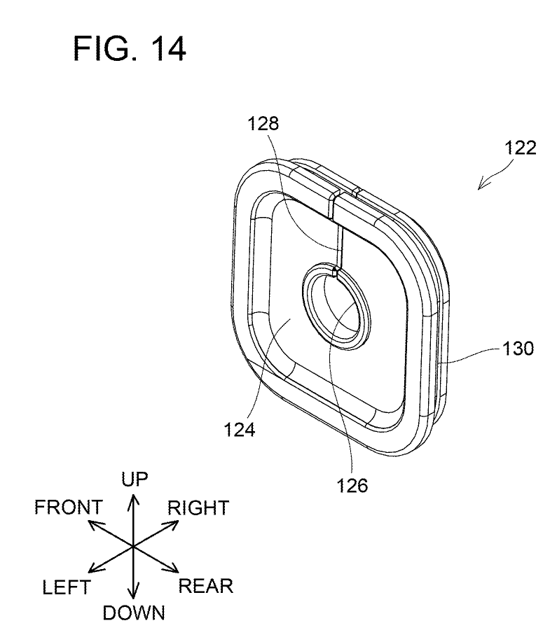

As illustrated in FIG. 14, the first sealing member 122 comprises a sealing member body 124, a fitting hole 126, a slit 128, and an attachment groove 130. The fitting hole 126 penetrates the sealing member body 124. The diameter of the fitting hole 126 is substantially the same as the diameter of the power cable 110 (see FIG. 11). Thus, the fitting hole 126 can fit around the outer surface of the power cable 110. The slit 128 extends from an end of the sealing member body 124 to the fitting hole 126. The user can fit the fitting hole 126 around the outer surface of the power cable 110 by flexing the sealing member body 124 to expand the slit 128 and then inserting the power cable 110 through the slit 128. Thereby, the first sealing member 122 is attached to the power cable 110. The attachment groove 130 is formed in the outer periphery of the sealing member body 124. The first sealing member 122 is attached to the through hole 120 (see FIG. 12) by the periphery of the through hole 120 being inserted into the attachment groove 130. The left wall of the attachment groove 130 projects longer than the right wall of the attachment groove 130. The periphery of the through hole 120 is moved over the right wall of the attachment groove 130 before inserted into the attachment groove 130. Thus, the first sealing member 122 is attached to the through hole 120 by being pushed into the through hole 120 with its right surface oriented toward the through hole 120.

In the state where the power adapter 94 (see FIG. 11) is not attached to the battery receptacle 16 (see FIG. 12) and the power cable 110 (see FIG. 11) does not extend through the through hole 120 as illustrated in FIG. 9, a second sealing member 132 is attached to the through hole 120 instead of the first sealing member 122 (see FIG. 14). The same rubber material as that of the first sealing member 122 is used for the second sealing member 132. The second sealing member 132 is attached to the through hole 120 to seal the through hole 120 without the power cable 110. The second sealing member 132 is attached to the through hole 120, for example, when the battery pack BP (see FIG. 10) is attached to the battery receptacle 16.

To attach the power adapter 94 (see FIG. 11) to the battery receptacle 16 illustrated in FIG. 12, the user first detaches the sealing member 122, 132 (see FIGS. 14 and 9) from the through hole 120. Subsequently, the user passes the power connector 112 and the power cable 110 through the through hole 120 and attaches the power adapter 94 to the battery receptacle 16. Then, the user attaches the first sealing member 122 (see FIG. 14) to a portion of the power cable 110 that is located outside the outer housing 12 (i.e., in the space leftward of the through hole 120) and slides the first sealing member 122 rightward along the outer surface of the power cable 110, thereby attaching the first sealing member 122, together with the power cable 110, to the through hole 120. As a result, as illustrated in FIG. 13, the power adapter 94 is attached to the battery receptacle 16 and the through hole 120 is sealed by the first sealing member 122 along with the power cable 110. In another example, the user may attach the first sealing member 122 to a portion of the power cable 110 that is located inside the outer housing 12 (i.e., in the space rightward of the through hole 120) and slide the first sealing member 122 leftward along the outer surface of the power cable 110, thereby attaching the first sealing member 122, together with the power cable 110, to the through hole 120. In this case, the first sealing member 122 may assume a left-right reversed orientation relative to its orientation illustrated in FIG. 13.

As illustrated in FIG. 15, the motor unit 2 further comprises the electric motor 134, a centrifugal fan 136, a motor housing 138, a control unit 140, a controller cover 142, and the mount base 144. The electric motor 134, the centrifugal fan 136, the motor housing 138, the control unit 140, the controller cover 142, and the mount base 144 are housed in the outer housing 12.

The electric motor 134 comprises a motor shaft 146, a rotor 148 fixed to the motor shaft 146, and a stator 150 located radially outward of the rotor 148. The rotor 148 comprises a permanent magnet 149 having magnetic poles arranged circumferentially. The stator 150 comprises teeth (not illustrated) on which coils 151 are wound. The electric motor 134 is a so-called inner-rotor electric motor. The motor shaft 146 is rotatably supported by the motor housing 138 and the mount base 144 via bearings 152, 190. The maximum output of the electric motor 134 may be in the range of 0.5 kW to 2.0 kW, and it may be, for example, in the range of 0.5 kW to 1.5 kW, in the range of 0.5 kW to 1.2 kW, or in the range of 0.5 kW to 1.0 kW. The electric motor 134 is housed in the motor housing 138. The controller cover 142 is attached to a rear portion of the motor housing 138. The controller cover 142 supports the control unit 140. Thus, the control unit 140 is offset rearward from the rear end of the motor shaft 146. The control unit 140 comprises a control circuit board 154 and a board case 156 to which the control circuit board 154 is fixed with a screw (not illustrated). The control circuit board 154 is oriented such that its thickness direction is along the front-rear direction. The control circuit board 154 is electrically connected to the connection terminals 118 (see FIG. 12) of the battery receptacle 16. The control circuit board 154 supplies electric power supplied to the connection terminals 118 to the electric motor 134. The control circuit board 154 adjusts electric power supplied to the electric motor 134 to control the output of the electric motor 134. A metal material (e.g., aluminum alloy) is used for the board case 156. The board case 156 comprises a case body 158 to which the control circuit board 154 is fixed and a plurality of fins 160 projecting forward from the front surface of the case body 158.

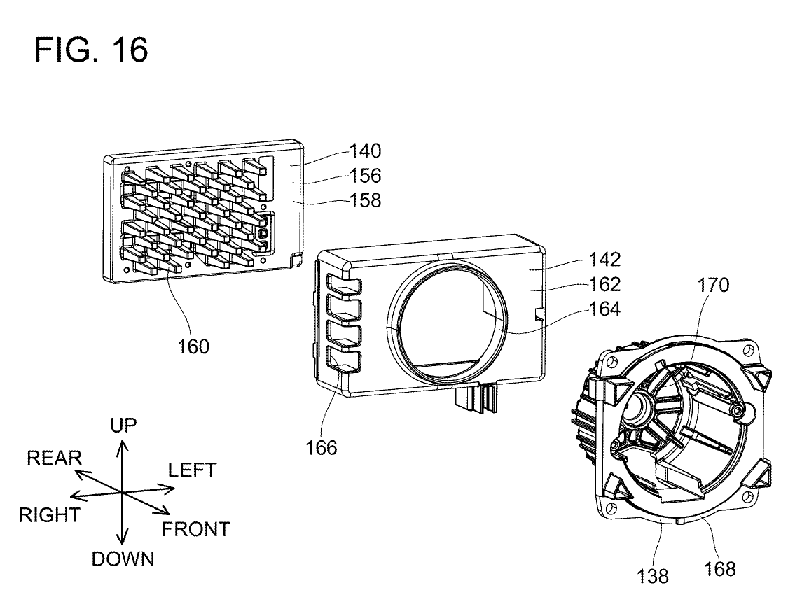

As illustrated in FIG. 16, the controller cover 142 comprises a controller cover body 162 which is open rearward, a cylindrical portion 164 located in a central portion of the front wall of the controller cover body 162, and first inner ventilation openings 166 formed in the connection between the right wall and the front wall of the controller cover body 162. The first inner ventilation openings 166 face first inlets 262 of a first cover assembly 254 (see FIG. 4). The controller cover 142 is attached to the motor housing 138 with the inner surface of the cylindrical portion 164 fitted with a rear end portion of the outer surface of the motor housing 138. The motor housing 138 comprises a motor housing body 168 and a second inner ventilation opening 170 penetrating the rear wall of the motor housing body 168 in the front-rear direction. The second inner ventilation opening 170 provides communication between the inside of the controller cover 142 and the inside of the motor housing 138.

As illustrated in FIG. 15, the centrifugal fan 136 is located frontward of the front end of the rotor 148 and is fixed to the motor shaft 146. The centrifugal fan 136 comprises a circular disk portion 136a radially extending from the rotation axis RX (i.e., extending in the up-down direction and the left-right direction) and a plurality of blades 136b projecting rearward from the rear surface of the circular disk portion 136a. The centrifugal fan 136 faces discharge openings 172 (see FIGS. 4 and 9) formed in the left wall and the right wall of the projecting portion 62 (see FIG. 4) of the outer housing 12 in the left-right direction. The centrifugal fan 136, when the motor shaft 146 rotates, causes an air flow. This air flow is for cooling the electric motor 134 and the control unit 140. Air flows into the outer housing 12 from the outside through the first inlets 262 of the first cover assembly 254 (see FIG. 4) and then flows into the controller cover 142 through the first inner ventilation openings 166 (see FIG. 16). After flowing into the controller cover 142, the air flows through the plurality of fins 160 and then flows into the motor housing 138 through the second inner ventilation openings 170 (see FIG. 16). After flowing into the motor housing 138, the air flows through the electric motor 134 and the centrifugal fan 136 and then flows out from the outer housing 12 through the discharge openings 172. This air flow removes heat generated at the control unit 140 and the electric motor 134 to the outside of the outer housing 12.

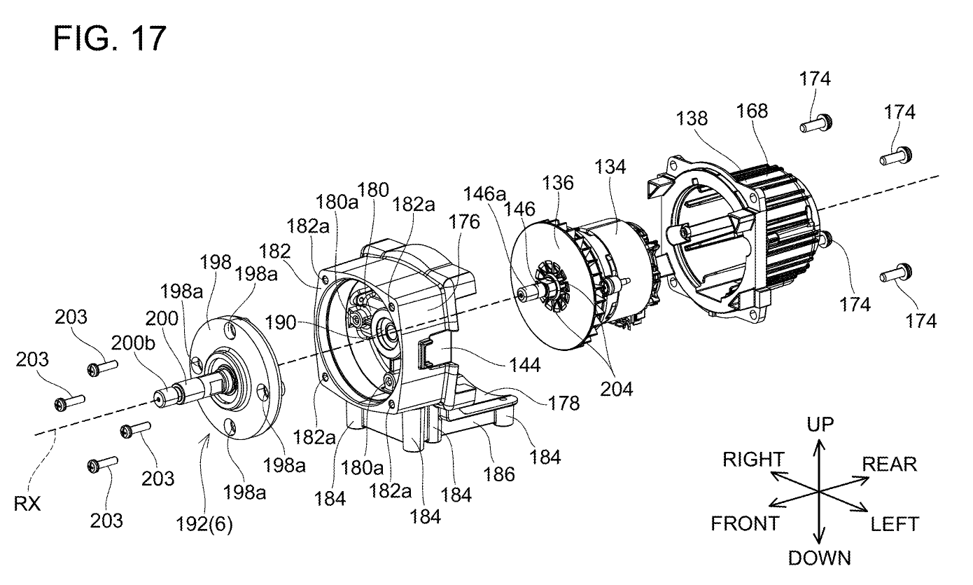

As illustrated in FIG. 17, the mount base 144 is fixed to the front end of the motor housing body 168 with four screws 174. The mount base 144 comprises a tubular portion 176, a bottom frame portion 178, and a partition wall portion 180. The inner surface of the tubular portion 176 has a substantially cylindrical shape. The front attachment surface 182 extends in the up-down direction and the left-right direction at the front end of the tubular portion 176. The front attachment surface 182 is orthogonal to the rotation axis RX. Four threaded holes 182a are formed in the front attachment surface 182. The four threaded holes 182a are formed in an upper left portion, a lower left portion, an upper right portion, and a lower right portion of the front attachment surface 182, respectively. Although details will be described later, the motor unit 2 can be attached to a working unit 500 with the front attachment surface 182 contacting the working unit 500.

The bottom frame portion 178 is connected to the lower surface of the tubular portion 176 and extends in the front-rear direction and the left-right direction. Six threaded bosses 184 and a reinforcement rib 186 are arranged across the lower surface of the tubular portion 176 and the lower surface of the bottom frame portion 178. The six threaded bosses 184 and the reinforcement rib 186 project downward from the lower surface of the tubular portion 176 (or the lower surface of the bottom frame portion 178). The reinforcement rib 186 connects the outer surfaces of the six threaded bosses 184 to each other. As illustrated in FIG. 9, a lower attachment surface 188 is located at the lower end of each of the six threaded bosses 184, and the lower attachment surfaces 188 extend in the front-rear direction and the left-right direction. The lower attachment surfaces 188 of the six threaded bosses 184 are flush with each other. The lower attachment surfaces 188 are parallel to the rotation axis RX. The lower attachment surfaces 188 are spaced by 75 mm from the rotation axis RX in the up-down direction for compatibility with GX35 available from Honda R&D Co., Ltd. Although details will be described later, the motor unit 2 can be attached to a working unit 500 with the lower attachment surfaces 188 contacting the working unit 500.

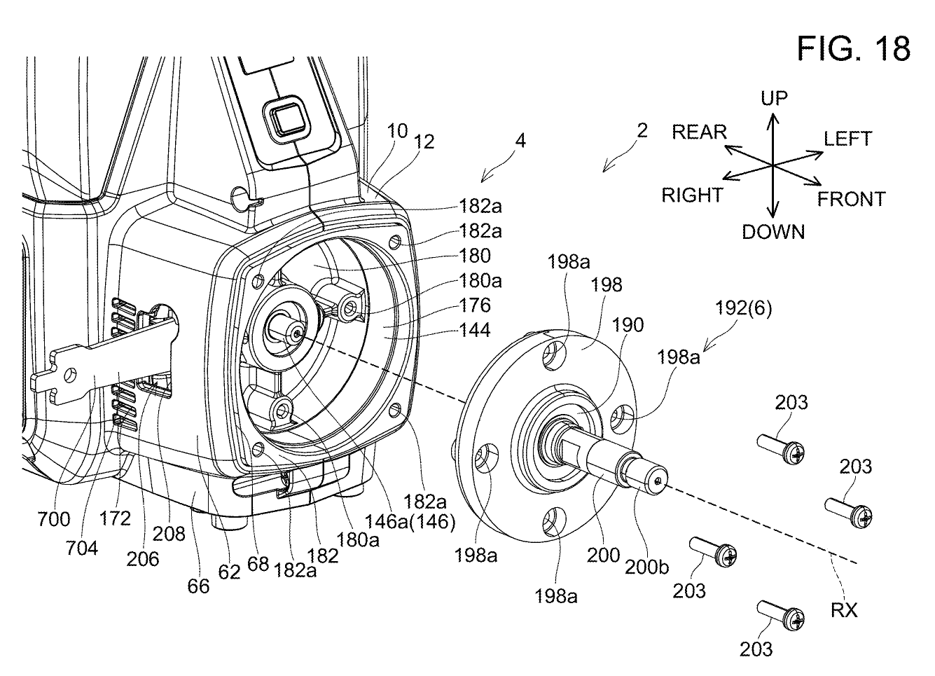

As illustrated in FIG. 17, the partition wall portion 180 extends in the up-down direction and the left-right direction within the tubular portion 176. The partition wall portion 180 partitions the internal space of the tubular portion 176 in the front-rear direction. The partition wall portion 180 faces the front surface of the circular disk portion 136a of the centrifugal fan 136. The motor shaft 146 penetrates the partition wall portion 180. The partition wall portion 180 supports the motor shaft 146 via the bearing 190 such that the motor shaft 146 is rotatable about the rotation axis RX. As illustrated in FIGS. 17 and 18, the partition wall portion 180 comprises four threaded holes 180a. The four threaded holes 180a penetrate the partition wall portion 180 in the front-rear direction. The four threaded holes 180a are located near the inner surface of the tubular portion 176. The four threaded holes 180a are located in an upper portion, a lower portion, a left portion, and a right portion of the partition wall portion 180, respectively.

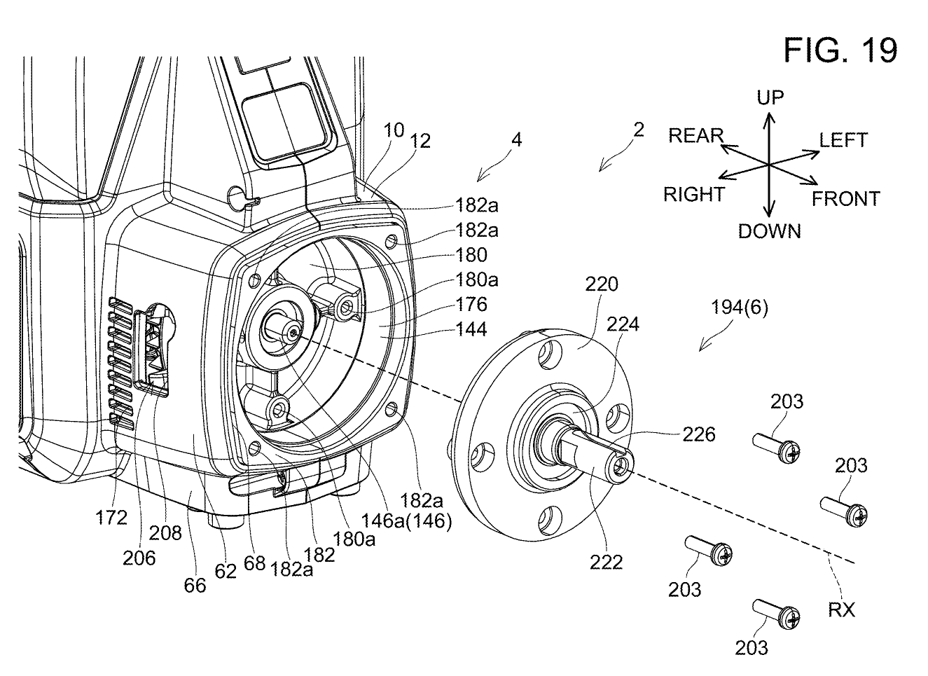

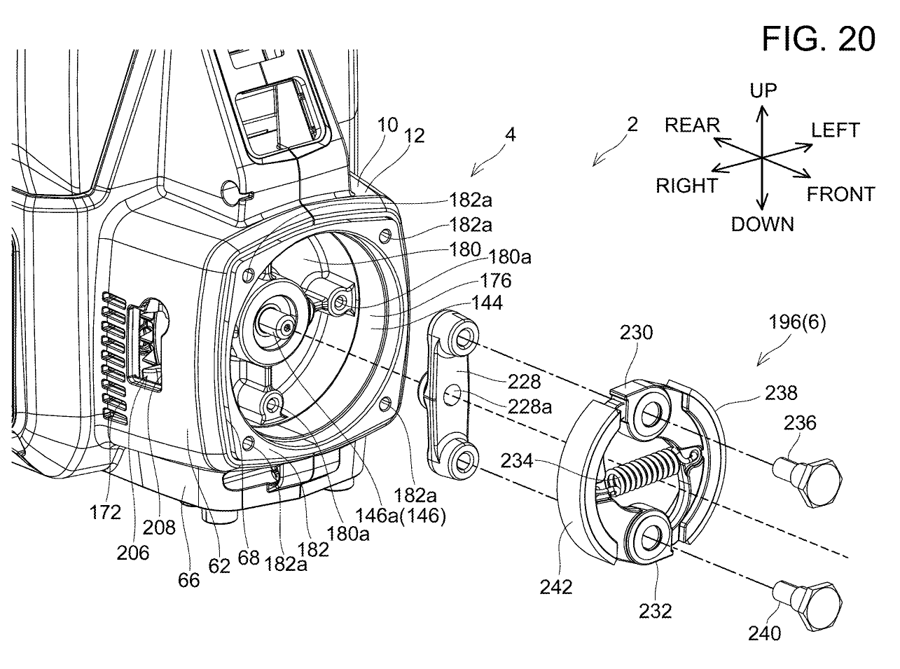

As illustrated in FIGS. 18, 19, and 20, there are multiple types of rotation output assemblies 6. The motor unit 2 selectively comprises one of the multiple types of rotation output assemblies 6. In the present embodiment, the rotation output assembly 6 illustrated in FIG. 18 is also referred to as a first rotation output assembly 192, the rotation output assembly 6 illustrated in FIG. 19 is also referred to as a second rotation output assembly 194, and the rotation output assembly 6 illustrated in FIG. 20 is also referred to as a third rotation output assembly 196. The multiple types of rotation output assemblies 6 are connected to a working unit 500 in different manners.

As illustrated in FIG. 18, the first rotation output assembly 192 comprises a first support member 198 and a first spindle 200. The first support member 198 has a circular disk shape extending in the up-down direction and the left-right direction. The first spindle 200 penetrates the first support member 198. The first support member 198 supports the first spindle 200 via a bearing 202 (see FIG. 15) such that the first spindle 200 is rotatable about the rotation axis RX. The first support member 198 comprises four insertion holes 198a aligned with the four threaded holes 180a of the partition wall portion 180. The first support member 198 is fixed to the front surface of the partition wall portion 180 by inserting four screws 203 into the four insertion holes 198a of the first support member 198 and screwing the screws 203 into the four threaded holes 180a of the partition wall portion 180.

As illustrated in FIG. 15, the first spindle 200 extends in the front-rear direction. An internal thread 200a is formed in a rear end portion (i.e., a base end portion) of the first spindle 200. An external thread 146ais formed in a front portion of the motor shaft 146, and the external thread 146a is configured to be screwed into the internal thread 200a. The first spindle 200 is fixed to the motor shaft 146 by screwing the external thread 146a and the internal thread 200a together. Thus, the first spindle 200 integrally rotates with the motor shaft 146 about the rotation axis RX. An external thread 200b is formed in a front end portion (i.e., distal end portion) of the first spindle 200. An internal thread (not illustrated) configured to screw with the external thread 200b is formed in a rotation element (e.g., an impeller of a water-lifting pump) of some working units 500. The first spindle 200 is connected to such a rotation element of the working unit 500 by screwing the external thread 200b and the internal thread together. Thus, the first spindle 200, when rotating, outputs driving power of the electric motor 134 to the working unit 500.

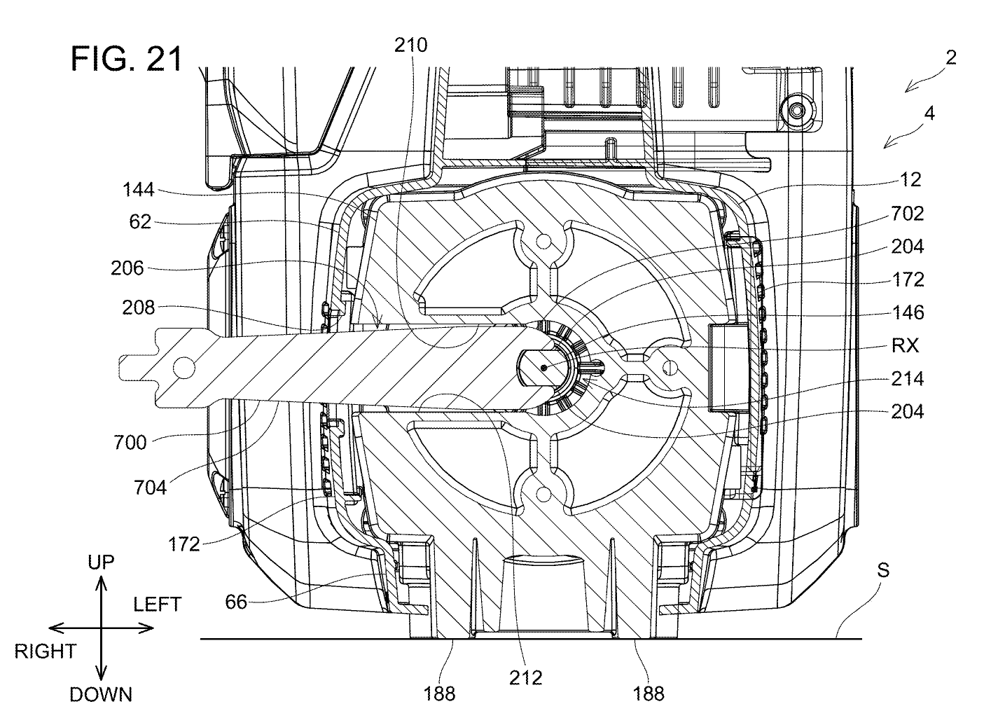

As illustrated in FIG. 17, two flat surfaces 204 parallel to each other are formed on the outer surface of the motor shaft 146. The two flat surfaces 204 are located frontward of the front surface of the circular disk portion 136a of the centrifugal fan 136 and rearward of the external thread 146a. When fastening the internal thread 200a (see FIG. 15) of the first spindle 200 to the external thread 146a of the motor shaft 146, an assembly worker can lock the rotation of the motor shaft 146 by engaging a jaw portion 702 (see FIG. 21) of a spanner 700 with the two flat surfaces 204. This allows the assembly worker to firmly fasten the external thread 146a and the internal thread 200a together, allowing for firm fixation of the first spindle 200 to the motor shaft 146. The same applies for fixing the rotation element of a working unit 500 to the first spindle 200. Specifically, the assembly worker can lock the rotation of the first spindle 200 already fixed to the motor shaft 146 by engaging the jaw portion 702 of the spanner 700 with the two flat surfaces 204. This allows the assembly worker to firmly fasten the external thread 200b of the first spindle 200 and the internal thread (not illustrated) of the rotation element of the working unit 500 together, allowing for firm fixation of the rotation element of the working unit 500 to the first spindle 200.

As illustrated in FIG. 21, the mount base 144 comprises a tool space 206 configured to receive the spanner 700 in the orientation in which the spanner 700 engages the two flat surfaces 204 of the motor shaft 146. The tool space 206 extends rightward as viewed from the two flat surfaces 204. The tool space 206 faces a tool opening 208 formed in the right wall of the projecting portion 62 of the outer housing 12 in the left-right direction. The tool opening 208 provides communication between the tool space 206 and the outside of the outer housing 12. The tool opening 208 is configured to allow the spanner 700 to pass therethrough in the longitudinal direction of the spanner 700 (i.e., in the direction from a handle portion 704 toward the jaw portion 702). Thus, the assembly worker can engage the jaw portion 702 with the two flat surfaces 204 by gripping the handle portion 704 of the spanner 700 and inserting the jaw portion 702 leftward into the tool opening 208. When the jaw portion 702 of the spanner 700 is engaged with the two flat surfaces 204, the longitudinal direction of the spanner 700 is substantially orthogonal to the rotation axis RX. When the lower attachment surfaces 188 of the mount base 144 are on a flat resting surface S, the direction from the space outside the outer housing 12 toward the tool space 206 via the tool opening 208 is substantially parallel to the resting surface S. This allows the assembly worker to easily insert and remove the spanner 700 into and from the tool opening 208 when the motor unit 2 is on the resting surface S. The mount base 144 further comprises an upper contact surface 210 defining the upper edge of the tool space 206 and a lower contact surface 212 defining the lower edge of the tool space 206. When the jaw portion 702 of the spanner 700 is engaged with the two flat surfaces 204, the upper contact surface 210 and the lower contact surface 212 each face the handle portion 704 of the spanner 700 in the circumferential direction of the rotation axis RX. When the assembly worker fastens the external thread 146a (see FIG. 15) and the internal thread 200a (see FIG. 15) together, torque is thereby applied to the motor shaft 146. At this time, the spanner 700 engaging the motor shaft 146 rotates together with the motor shaft 146 about the rotation axis RX and eventually contacts the upper contact surface 210 (or the lower contact surface 212). When the spanner 700 is in contact with the upper contact surface 210 (or the lower contact surface 212), a force for locking the motor shaft 146 against the torque associated with the thread fastening (i.e., reaction force) is applied to the spanner 700 from the upper contact surface 210 (or the lower contact surface 212). Therefore, the assembly worker does not have to apply a force to the spanner 700 to obtain the reaction force, which allows the assembly worker to perform the thread fastening without gripping the spanner 700. In the present embodiment, the two flat surfaces 204, the tool space 206, the upper contact surface 210, the lower contact surface 212, and the tool opening 208 are also collectively termed “a shaft lock mechanism 214”.

As illustrated in FIG. 18, the spanner 700 received in the tool space 206 is partially housed in the outer housing 12. Further, the spanner 700 received in the tool space 206 partially projects laterally from the mount base 144 but does not project forward beyond the mount base 144 (specifically, does not project forward beyond the front attachment surface 182). Therefore, the spanner 700 is prevented from interfering with operations performed in front of the mount base 144 (e.g., an operation of fixing the first spindle 200 to the motor shaft 146, an operation of fixing the first support member 198 to the mount base 144, an operation of connecting the rotation element of a working unit 500 to the first spindle 200, etc.).

As illustrated in FIG. 4, the tool opening 208 is usually closed with a lid 216. The lid 216 is fastened to each of the outer housing 12 and the mount base 144 with a screw 218.

As illustrated in FIG. 19, the second rotation output assembly 194 comprises a second support member 220 and a second spindle 222. Similarly to the first support member 198 (see FIG. 18), the second support member 220 is fixed to the mount base 144. The second support member 220 supports the second spindle 222 via a bearing 224 such that the second spindle 222 is rotatable. The second spindle 222 is different from the first spindle 200 (see FIG. 18) in that the former comprises a key groove 226 instead of the external thread 200b. A key (not illustrated) configured to engage the key groove 226 is formed on the rotation elements of some working units 500 (e.g., a pulley 546 of the plate compactor 500b (see FIG. 2)). The second spindle 222 is connected to such a rotation element of working unit 500 by engaging the key with the key groove 226. In the example illustrated in FIG. 19 as well, time and effort required to assemble the motor unit 2 (or an electric working machine) can be reduced by locking the rotation of the motor shaft 146 using the shaft lock mechanism 214 (see FIG. 21). For example, time and effort required to fix the second spindle 222 to the motor shaft 146 and to connect the rotation element of a working unit 500 to the second spindle 222 can be reduced.

As illustrated in FIG. 20, the third rotation output assembly 196 comprises a drive member 228, a first clutch shoe 230, a second clutch shoe 232, and a clutch spring 234. The drive member 228 comprises an internal thread 228a engageable with the external thread 146a of the motor shaft 146. The drive member 228 is fixed to the motor shaft 146 by screwing the external thread 146a and the internal thread 228a together. Thus, the drive member 228 integrally rotates with the motor shaft 146 about the rotation axis RX. The first clutch shoe 230 has an arc shape. One end of the first clutch shoe 230 is fixed to one end of the drive member 228 with a first bolt 236. The first clutch shoe 230 is pivotable relative to the drive member 228 about the first bolt 236. A first friction member 238 is fixed to the outer periphery of the first clutch shoe 230. The second clutch shoe 232 has substantially the same shape as that of the first clutch shoe 230. One end of the second clutch shoe 232 is fixed to the other end of the drive member 228 with a second bolt 240. The second clutch shoe 232 is pivotable relative to the drive member 228 about the second bolt 240. A second friction member 242 is fixed to the outer periphery of the second clutch shoe 232. The clutch spring 234 is attached to each of the first clutch shoe 230 and the second clutch shoe 232. The clutch spring 234 is, for example, a tension spring. The clutch spring 234 biases the first clutch shoe 230 and the second clutch shoe 232 toward each other.

When the motor shaft 146 rotates about the rotation axis RX, the first clutch shoe 230 and the second clutch shoe 232 also rotate about the rotation axis RX. As the rotation speed of the motor shaft 146 increases, the centrifugal force applied to the first clutch shoe 230 and the second clutch shoe 232 increases as well and the first clutch shoe 230 and the second clutch shoe 232 pivot away from each other against the biasing force of the clutch spring 234. As a result, the first friction member 238 on the first clutch shoe 230 and the second friction member 242 on the second clutch shoe 232 are pressed against the inner surface of a drum (not illustrated) of a working unit 500. Thereby, the rotation of the motor shaft 146 is transmitted to the drum and the drum integrally rotates with the motor shaft 146 about the rotation axis RX.

In the example illustrated in FIG. 20 as well, time and effort required to assemble the motor unit 2 (or an electric working machine) can be reduced by locking the rotation of the motor shaft 146 using the shaft lock mechanism 214 (see FIG. 21). For example, time and effort required to fix drive member 228 to the motor shaft 146 can be reduced.

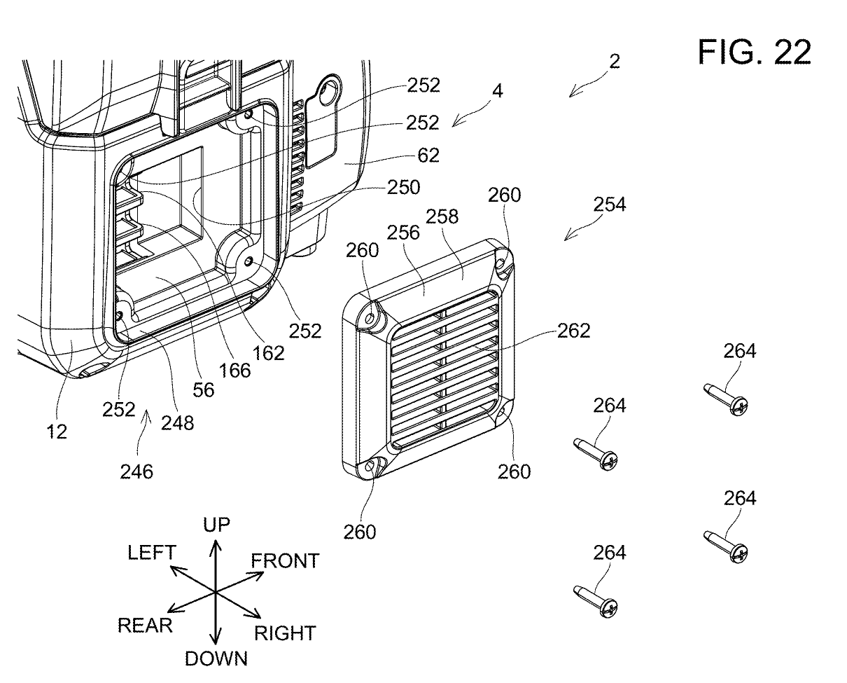

As illustrated in FIG. 22, the motor unit 2 comprises a right assembly receptacle 246 formed in the lower right wall 56 of the outer housing 12 and a first cover assembly 254 configured to be attached to the right assembly receptacle 246.

The right assembly receptacle 246 comprises a right surrounding wall 248, a right communication opening 250, and four threaded holes 252. The right surrounding wall 248 projects rightward from the outer surface of the lower right wall 56. The right surrounding wall 248 has a substantially square frame shape. The right communication opening 250 penetrates the lower right wall 56 in the left-right direction. The right communication opening 250 is surrounded by the right surrounding wall 248. The right communication opening 250 provides communication between the inside of the outer housing 12 and the outside of the outer housing 12.

The first cover assembly 254 comprises a first inlet cover 256. The first inlet cover 256 comprises a first inlet cover body 258 configured to engage the right surrounding wall 248, four insertion holes 260 formed in an upper left portion, a lower left portion, an upper right portion, and a lower right portion of the first inlet cover body 258, respectively, and first inlets 262 formed in a central portion of the first inlet cover body 258. The four insertion holes 260 are aligned with the four threaded holes 252 of the right assembly receptacle 246. The first inlet cover 256 is attached to the right assembly receptacle 246 by inserting four screws 264 into the four insertion holes 260 of the first inlet cover 256 and fastening the four screws 264 to the four threaded holes 252 of the right assembly receptacle 246. The first inlets 262 face the right communication opening 250. When the centrifugal fan 136 (see FIG. 15) rotates, air flows into the outer housing 12 from the outside of the outer housing 12 through the first inlets 262 and the right communication opening 250, resulting in the air flow generated by the rotation of the centrifugal fan 136.

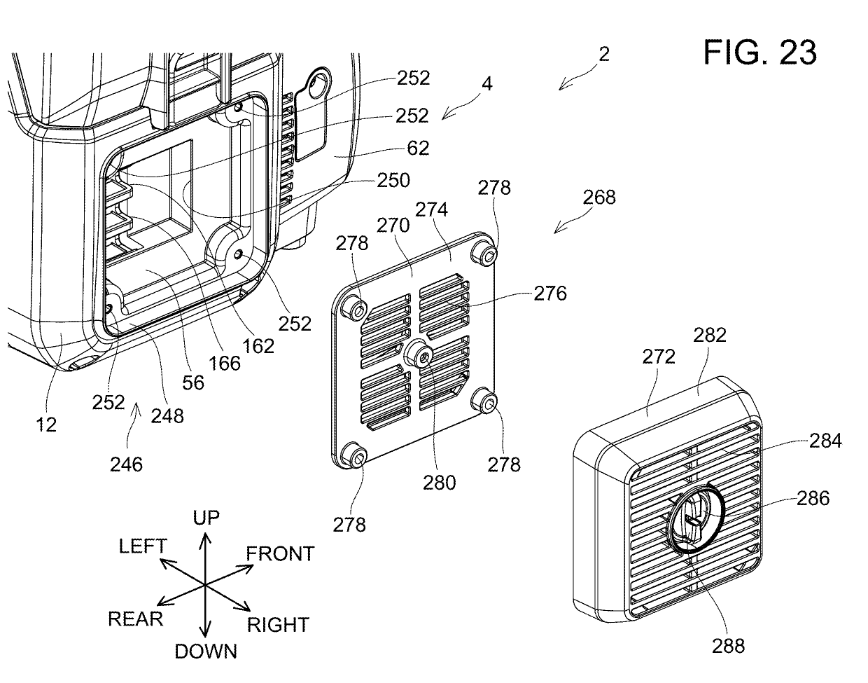

As illustrated in FIG. 23, a second cover assembly 268 may be attached to the right assembly receptacle 246 instead of the first cover assembly 254 (see FIG. 22). The second cover assembly 268 comprises an inner housing 270 and a second inlet cover 272. The inner housing 270 comprises an inner housing body 274 having a substantially square shape, filter openings 276 penetrating the inner housing 270 in the left-right direction, four bored bosses 278 located in an upper left portion, a lower left portion, an upper right portion, and a lower right portion of the inner housing body 274, respectively, and a threaded boss 280 located in a central portion of the inner housing body 274. A filter member (not illustrated) such as a sponge is disposed between the inner housing 270 and the second inlet cover 272. The four bored bosses 278 are aligned with the four threaded holes 252 of the right assembly receptacle 246. Similarly to the first inlet cover 256, the inner housing 270 is fastened to the right assembly receptacle 246 with the four screws 264 (see FIG. 22). Specifically, the inner housing 270 is attached to the right assembly receptacle 246 by inserting the four screws 264 into the four bored bosses 278 of the inner housing 270 and fastening them to the threaded holes 252 of the right assembly receptacle 246. The second inlet cover 272 comprises a second inlet cover body 282 covering the right surface of the inner housing 270, second inlets 284 penetrating the second inlet cover body 282 in the left-right direction, and a screw member 286 rotatably attached to a central portion of the second inlet cover body 282. The second inlet cover 272 is fixed to the inner housing 270 by screwing the screw member 286 into the threaded boss 280 of the inner housing 270. The second inlets 284 are aligned with the filter openings 276 and the right communication opening 250 in the left-right direction. When the centrifugal fan 136 (see FIG. 15) rotates, air flows into the outer housing 12 from the outside of the outer housing 12 through the second inlets 284, the filter openings 276, and the right communication opening 250, resulting in the air flow generated by the rotation of the centrifugal fan 136. The screw member 286 comprises a user-operable knob 288. The user can loosen and tighten the screw member 286 by operating the knob 288. The user can loosen the screw member 286 to detach the second inlet cover 272 from the inner housing 270. The user can detach the second inlet cover 272 from the inner housing 270 to replace the filter member. The second cover assembly 268 prevents entry of liquid (e.g., water, fresh concrete) and dust into the outer housing 12, by the filter member.

As described above, the motor unit 2 selectively comprises one of multiple types of cover assemblies. The first cover assembly 254 illustrated in FIG. 22 is suitable, for example, for manufacturing the motor unit 2 at a relatively low cost. The second cover assembly 268 illustrated in FIG. 23 is suitable, for example, for using the motor unit 2 in an environment involving liquid and/or dust.

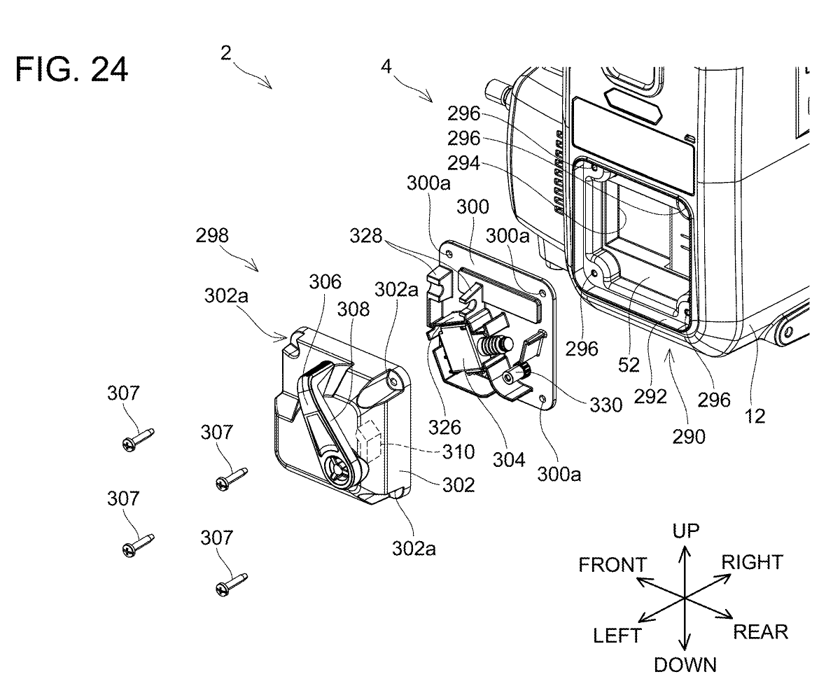

As illustrated in FIG. 24, the motor unit 2 comprises a left assembly receptacle 290 formed in the lower left wall 52 of the outer housing 12 and a first input assembly 298 configured to be attached to the left assembly receptacle 290.

The left assembly receptacle 290 comprises a left surrounding wall 292, a left communication opening 294, and four threaded holes 296. The left surrounding wall 292 projects leftward from the outer surface of the lower left wall 52. The left surrounding wall 292 has a substantially square frame shape. The left communication opening 294 penetrates the lower left wall 52 in the left-right direction. The left communication opening 294 is surrounded by the left surrounding wall 292. The left communication opening 294 provides communication between the inside of the outer housing 12 and the outside of the outer housing 12.

The first input assembly 298 comprises a first support plate 300, a first assembly cover 302, a switch 304, and a first lever 306. The first support plate 300 has a substantially square shape. The first assembly cover 302 covers the left surface of the first support plate 300. Four insertion holes 300a are formed in the first support plate 300, and the four insertion holes 300a are aligned with the four threaded holes 296 of the left assembly receptacle 290. Similarly, four insertion holes 302a are formed in the first assembly cover 302, and the four insertion holes 302a are aligned with the four threaded holes 296 of the left assembly receptacle 290. The first support plate 300 and the first assembly cover 302 are attached to the left assembly receptacle 290 by inserting four screws 307 into the four insertion holes 302a of the first assembly cover 302 and the four insertion holes 300a of the first support plate 300 and screwing them into the four threaded holes 296 of the left assembly receptacle 290. The switch 304 is supported by the first support plate 300. The first lever 306 is pivotably attached to the first assembly cover 302 about its pivot axis extending in the left-right direction. The first lever 306 comprises an operation portion 308 located on the left surface of the first assembly cover 302 and a push portion 310 located on the right surface of the first assembly cover 302. The operation portion 308 is operable by the user. The push portion 310 is in contact with the switch 304. When the first lever 306 is operated, the switch 304 is pushed by the push portion 310. The push displacement of the switch 304 varies depending on the position of the first lever 306. The switch 304 is electrically connected to the control circuit board 154 (see FIG. 15) and inputs the push displacement to the control circuit board 154. The control circuit board 154 controls the output of the electric motor 134 (see FIG. 15) according to the push displacement of the switch 304 (i.e., the position of the first lever 306). For example, the control circuit board 154 increases or decreases the output of the electric motor 134 according to an increase or decrease in the push displacement of the switch 304. Thus, the user can adjust the output of the electric motor 134 by adjusting the position of the first lever 306 to adjust the push displacement of the switch 304.

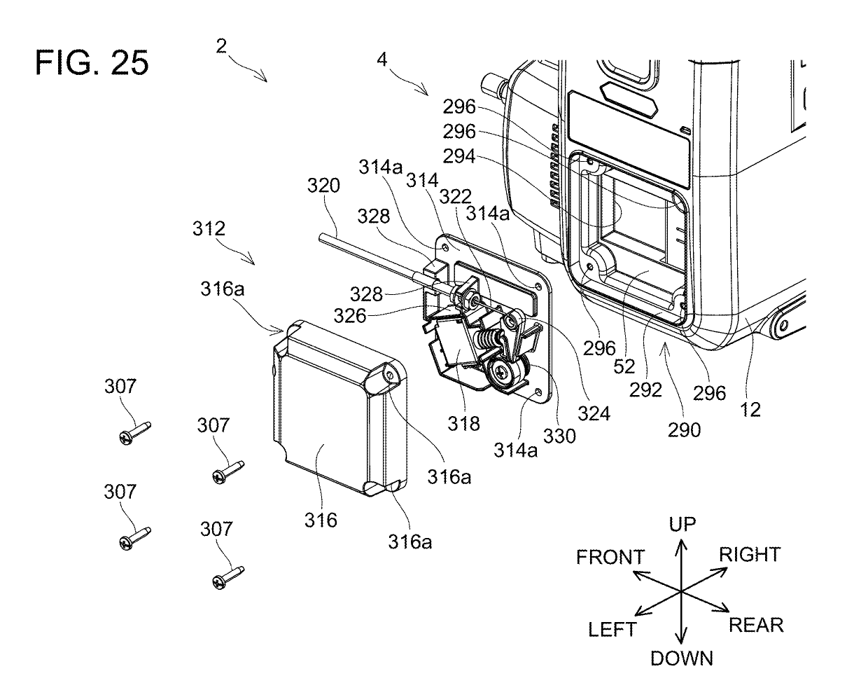

As illustrated in FIG. 25, a second input assembly 312 may be attached to the left assembly receptacle 290 instead of the first input assembly 298 (see FIG. 24). The second input assembly 312 comprises a second support plate 314, a second assembly cover 316, a switch 318, a pipe 320, a wire 322, and a push member 324. The second support plate 314 has a substantially square shape. The second assembly cover 316 covers the left surface of the second support plate 314. Four insertion holes 314a are formed in the second support plate 314, and the four insertion holes 314a are aligned with the four threaded holes 296 of the left assembly receptacle 290. Similarly, four insertion holes 316a are formed in the second assembly cover 316, and the four insertion holes 316a are aligned with the four threaded holes 296 of the left assembly receptacle 290. The second support plate 314 and the second assembly cover 316 are attached to the left assembly receptacle 290 by inserting the four screws 307 into the four insertion holes 316a of the second assembly cover 316 and the four insertion holes 314a of the second support plate 314 and screwing them to the four threaded holes 296 of the left assembly receptacle 290. A switch support piece 326 supporting the switch 318, a pipe support piece 328 supporting the pipe 320, and a support projection 330 supporting the push member 324 are located on the left surface of the second support plate 314. The second support plate 314 has the same shape as that of the first support plate 300 (see FIG. 24). Thus, the second support plate 314 can be used both in the first input assembly 298 (see FIG. 24) and the second input assembly 312.

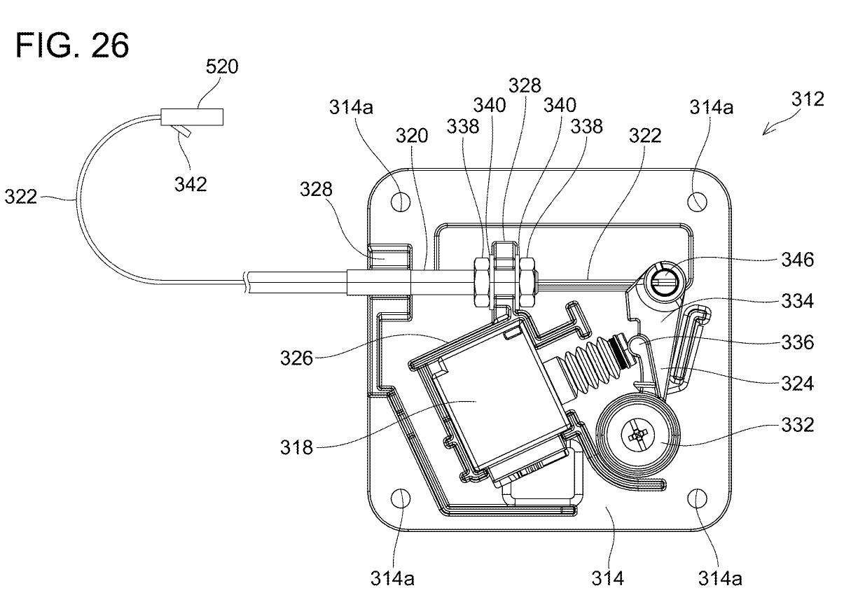

As illustrated in FIG. 26, the push member 324 comprises a shaft portion 332 supported by the support projection 330 (see FIG. 24), an arm portion 334 projecting from the outer surface of the shaft portion 332, and a push portion 336 located on an intermediate portion of the arm portion 334. The shaft portion 332 is pivotable relative to the support projection 330 about its pivot axis extending in the left-right direction. The push portion 336 is in contact with the switch 318. The pipe 320 is fixed to the pipe support piece 328 with two nuts 338 and two washers 340. The pipe 320 extends in the front-rear direction and penetrates the front wall of the second assembly cover 316 (see FIG. 25). The wire 322 extends through the pipe 320 and traverses across the outside and inside of the second assembly cover 316. The base end of the wire 322 is connected to a user-operable second lever 342. The second lever 342 is located, for example, on a portion gripped by the user when the user uses an electric working machine (e.g., on a grip 520 illustrated in FIG. 1). The distal end of the wire 322 is connected to the upper end of the arm portion 334 of the push member 324. When the wire 322 is pulled into the pipe 320 in response to the second lever 342 being operated, the push member 324 pivots about the support projection 330 and the switch 318 is thereby pushed. The user can adjust the output of the electric motor 134 (see FIG. 15) by adjusting the pull displacement of the wire 322 to adjust the push displacement of the switch 318. Even when the motor unit 2 is out of reach of the user, the user can adjust the output of the electric motor 134 by extending the wire 322 to locate the second lever 342 within reach of the user.

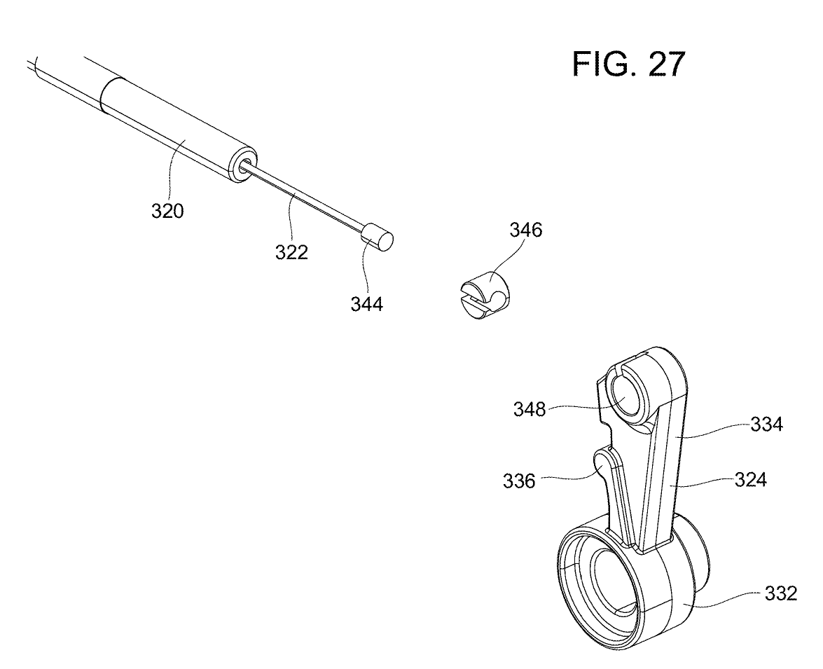

As illustrated in FIG. 27, a cylindrical end metal fitting 344 is attached to the distal end of the wire 322. However, since business operators (e.g., manufacturers of electric working machines) other than the manufacturer of the motor unit 2 may prepare wires 322, the size (i.e., diameter) of the end metal fitting 344 cannot be fixed to a specific size. Therefore, sometimes a large-diameter end metal fitting 344 (not illustrated) may be attached to the distal end of the wire 322, and a small-diameter end metal fitting 344 may be attached to the distal end of the wire 322. In view of this, in the present embodiment, the second input assembly 312 comprises a cylindrical joint member 346 configured to be detachably attached to the small-diameter end metal fitting 344. The arm portion 334 of the push member 324 receives the joint member 346 by a cylindrical surface 348 along the outer surface of the joint member 346 such that the joint member 346 is rotatable. Thus, in case the small-diameter end metal fitting 344 is attached to the distal end of the wire 322, the distal end of the wire 322 is connected to the arm portion 334 of the push member 324 via the joint member 346. In contrast, in case the large-diameter end metal fitting 344 is attached to the distal end of the wire 322, the distal end of the wire 322 is connected to the arm portion 334 of the push member 324 by inserting the end metal fitting 344 directly to the cylindrical surface 348, without using the joint member 346. Thus, the second input assembly 312 is applicable to both the large-diameter end metal fitting 344 and the small-diameter end metal fitting 344.

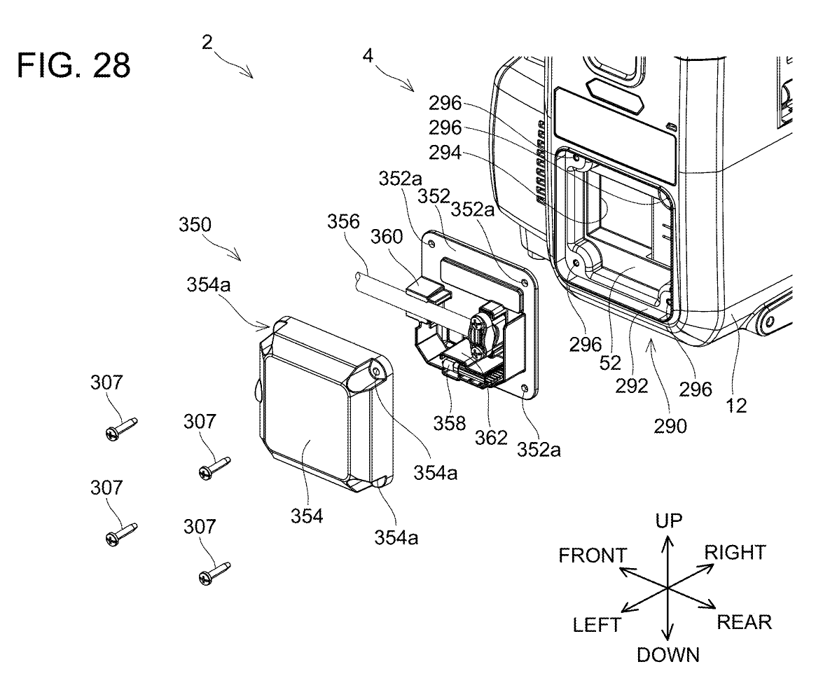

As illustrated in FIG. 28, a third input assembly 350 may be attached to the left assembly receptacle 290 instead of the first input assembly 298 (see FIG. 24). The third input assembly 350 comprises a third support plate 352, a third assembly cover 354, a communication cable 356, and a communication connector 358. The third support plate 352 has a substantially square shape. The third assembly cover 354 covers the left surface of the third support plate 352. Four insertion holes 352a are formed in the third support plate 352, and the four insertion holes 352a are aligned with the four threaded holes 296 of the left assembly receptacle 290. Similarly, four insertion holes 354a are formed in the third assembly cover 354, and the four insertion holes 354a are aligned with the four threaded holes 296 of the left assembly receptacle 290. The third support plate 352 and the third assembly cover 354 are attached to the left assembly receptacle 290 by inserting the four screws 307 into the four insertion holes 354a of the third assembly cover 354 and the four insertion holes 352a of the third support plate 352 and screwing them into the four threaded holes 296 of the left assembly receptacle 290. A cable support piece 360 and a connector support piece 362 are located on the left surface of the third support plate 352. The cable support piece 360 supports the communication cable 356. The connector support piece 362 supports the communication connector 358. The communication cable 356 extends in the front-rear direction and penetrates the front wall of the third assembly cover 354. One end of the communication cable 356 is electrically connected to an external device located outside the motor unit 2. The opposite end of the communication cable 356 is electrically connected to the control circuit board 154 (see FIG. 15) via the communication connector 358. The external device inputs specific information to the control circuit board 154 via the communication cable 356 and the communication connector 358. The control circuit board 154 controls the output of the electric motor 134 (see FIG. 15) automatically (i.e., without user’s operation) based on the information input from the external device. For example, in case the pressure washer 500c (see FIG. 3) is used as a working unit 500, the working unit 500 comprises a water pressure sensor 566 (see FIG. 3) for detection of water pressure. In this case, the water pressure sensor 566 is used as the external device, and a motor control signal based on the water pressure detected by the water pressure sensor 566 is input to the control circuit board 154. The control circuit board 154 may cause the electric motor 134 to drive in case the water pressure detected by the water pressure sensor 566 is less than a predetermined value, while the control circuit board 154 may cause the electric motor 134 to stop in case the water pressure detected by the water pressure sensor 566 is equal to or greater than the predetermined value.

As described above, the motor unit 2 selectively comprises one of multiple types of input assemblies. The input assembly to be used in the motor unit 2 is selected, for example, taking into account the convenience of the user of the working unit 500. The first input assembly 298 illustrated in FIG. 24 is suitable when the motor unit 2 is used within reach of the user, such as when the motor unit 2 is attached to the plate compactor 500b (see FIG. 2) and used. The second input assembly 312 illustrated in FIG. 25 is suitable when the motor unit 2 is used out of reach of the user, such as when the motor unit 2 is attached to the portable grass cutter 500a (see FIG. 1) and used. The third input assembly 350 illustrated in FIG. 28 is suitable for controlling the output of the electric motor 134 based on information generated by an external device, such as when the motor unit 2 is attached to the pressure washer 500c (see FIG. 3) and used.

The shape of the right assembly receptacle 246 illustrated in FIG. 22 is substantially the same as the shape of the left assembly receptacle 290 illustrated in FIG. 24. Thus, the first cover assembly 254 illustrated in FIG. 22 (and the second cover assembly 268 illustrated in FIG. 23) can be attached not only to the right assembly receptacle 246 but also to the left assembly receptacle 290. Similarly, the first input assembly 298 illustrated in FIG. 24 (and the second input assembly 312 illustrated in FIG. 25 and the third input assembly 350 illustrated in FIG. 28) can be attached not only to the left assembly receptacle 290 but also to the right assembly receptacle 246. Thus, the positions are interchangeable between the first cover assembly 254 and the second cover assembly 268 and the first input assembly 298, the second input assembly 312, and the third input assembly 350. The first inner ventilation openings 166 of the controller cover 142 (see FIG. 16) may be formed in the left wall of the controller cover body 162 (see FIG. 16) to face the first inlets 262 of the first cover assembly 254 (or the second inlets 284 of the second cover assembly 268) attached to the left assembly receptacle 290.

The first cover assembly 254 illustrated in FIG. 22 can be attached to the right assembly receptacle 246 selectively in any one of four orientations including: the orientation illustrated in FIG. 22; an orientation rotated 90 degrees about a rotation axis extending in the left-right direction from the orientation illustrated in FIG. 22; an orientation rotated 180 degrees about the rotation axis extending in the left-right direction from the orientation illustrated in FIG. 22; and an orientation rotated 270 degrees about the rotation axis extending in the left-right direction from the orientation illustrated in FIG. 22. The orientation of the first cover assembly 254 can also be selected from the four orientations when the first cover assembly 254 is attached to the left assembly receptacle 290 (see FIG. 24).

The second cover assembly 268 illustrated in FIG. 23 can be attached to the right assembly receptacle 246 selectively in any one of four orientations including: the orientation illustrated in FIG. 23; an orientation rotated 90 degrees about a rotation axis extending in the left-right direction from the orientation illustrated in FIG. 23; an orientation rotated 180 degrees about the rotation axis extending in the left-right direction from the orientation illustrated in FIG. 23; and an orientation rotated 270 degrees about the rotation axis extending in the left-right direction from the orientation illustrated in FIG. 23. The orientation of the second cover assembly 268 can also be selected from the four orientations when the second cover assembly 268 is attached to the left assembly receptacle 290 (see FIG. 24).

The first input assembly 298 illustrated in FIG. 24 can be attached to the left assembly receptacle 290 selectively in any one of four orientations including: the orientation illustrated in FIG. 24; an orientation rotated 90 degrees about a rotation axis extending in the left-right direction from the orientation illustrated in FIG. 24; an orientation rotated 180 degrees about the rotation axis extending in the left-right direction from the orientation illustrated in FIG. 24; and an orientation rotated 270 degrees about the rotation axis extending in the left-right direction from the orientation illustrated in FIG. 24. The orientation of the first input assembly 298 can also be selected from the four orientations when the first input assembly 298 is attached to the right assembly receptacle 246 (see FIG. 22).

The second input assembly 312 illustrated in FIG. 25 can be attached to the left assembly receptacle 290 selectively in any one of four orientations including: the orientation illustrated in FIG. 25; an orientation rotated 90 degrees about a rotation axis extending in the left-right direction from the orientation illustrated in FIG. 25; an orientation rotated 180 degrees about the rotation axis extending in the left-right direction from the orientation illustrated in FIG. 25; and an orientation rotated 270 degrees about the rotation axis extending in the left-right direction from the orientation illustrated in FIG. 25. The orientation of the second input assembly 312 can also be selected from the four orientations when the second input assembly 312 is attached to the right assembly receptacle 246 (see FIG. 22).

The third input assembly 350 illustrated in FIG. 28 can be attached to the left assembly receptacle 290 selectively in any one of four orientations including: the orientation illustrated in FIG. 28; an orientation rotated 90 degrees about a rotation axis extending in the left-right direction from the orientation illustrated in FIG. 28; an orientation rotated 180 degrees about the rotation axis extending in the left-right direction from the orientation illustrated in FIG. 28; and an orientation rotated 270 degrees about the rotation axis extending in the left-right direction from the orientation illustrated in FIG. 28. The orientation of the third input assembly 350 can also be selected from the four orientations when the third input assembly 350 is attached to the right assembly receptacle 246 (see FIG. 22).

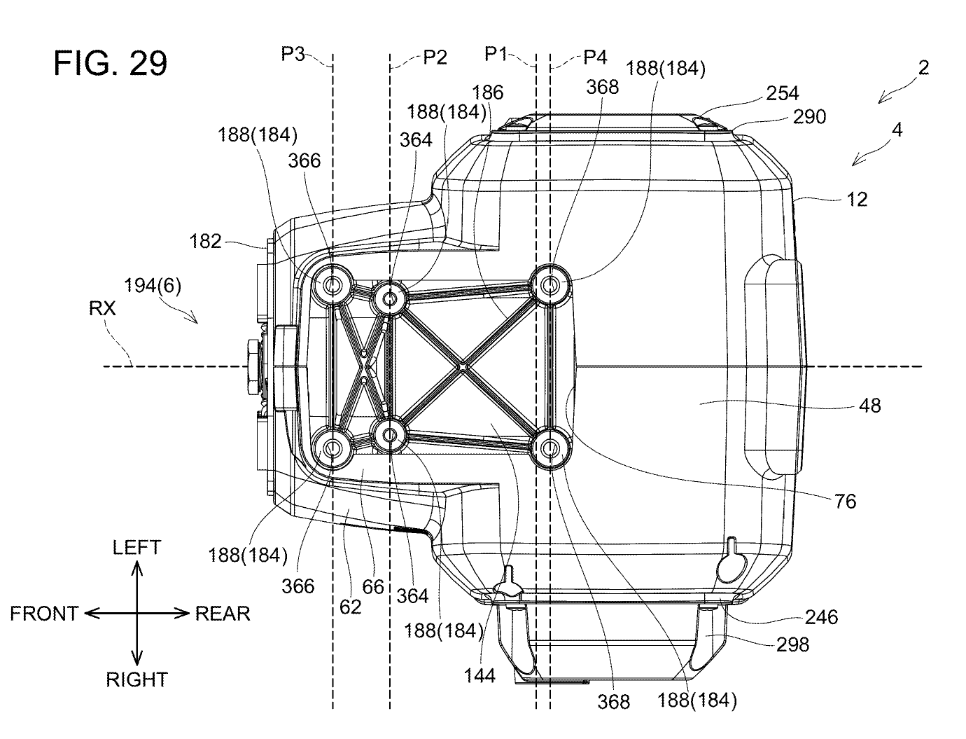

As illustrated in FIG. 29, the mount base 144 comprises two compatible holes 364, two front accessory holes 366, and two rear accessory holes 368 formed in the lower attachment surfaces 188. The two compatible holes 364, the two front accessory holes 366, and the two rear accessory holes 368 are threaded holes defined in the six threaded bosses 184. The two compatible holes 364 are aligned in the left-right direction. The two compatible holes 364 have a nominal diameter of 5 mm, a center‑to‑center distance of 50 mm, and a distance from the front attachment surface 182 to their central axes in the front-rear direction (i.e., the distance between the front attachment surface 182 and a second virtual plane P2) of 45 mm for compatibility with GX35 available from Honda R&D Co., Ltd. The two front accessory holes 366 and the two rear accessory holes 368 have a larger nominal diameter (e.g., 6 mm) than the nominal diameter of the two compatible holes 364 (i.e., 5 mm). The nominal diameter of the two front accessory holes 366 is the same as that of the two rear accessory holes 368. The two front accessory holes 366 are located frontward of the two compatible holes 364 and aligned in the left-right direction. The center-to-center distance between the two front accessory holes 366 is greater than the center-to-center distance between the two compatible holes 364 (i.e., 50 mm). The center-to-center distance between the two front accessory holes 366 is, for example, 60 mm. The two rear accessory holes 368 are located rearward of the two compatible holes 364 and aligned in the left-right direction. The center-to-center distance between the two rear accessory holes 368 is the same as the center-to-center distance between the two front accessory holes 366. The center-to-center distance between the two rear accessory holes 368 is, for example, 60 mm.

FIG. 29 illustrates a first virtual plane P1 that bisects the motor unit body 4 between the front end of the motor unit body 4 (i.e., the front attachment surface 182) and the rear end thereof (i.e., the rear surface of the outer housing 12). The two front accessory holes 366 are located frontward of the first virtual plane P1. The two rear accessory holes 368 are located rearward of the first virtual plane P1. FIG. 29 also illustrates the second virtual plane P2 passing through the centers of the two compatible holes 364, a third virtual plane P3 passing through the centers of the two front accessory holes 366, and a fourth virtual plane P4 passing through the centers of the two rear accessory holes 368. The distance between the second virtual plane P2 and the fourth virtual plane P4 is greater than the distance between the second virtual plane P2 and the third virtual plane P3. The distance between the second virtual plane P2 and the fourth virtual plane P4 is in the range of 55 mm to 155 mm, and it is, for example, 59 mm. The distance between the second virtual plane P2 and the third virtual plane P3 is in the range of 10 mm to 38 mm, and it is, for example, 21 mm.

As illustrated in FIG. 1, the motor unit 2 can be attached to a working unit 500 via the two compatible holes 364 (see FIG. 29) in the same manner as GX35. In the example illustrated in FIG. 1, the working unit 500 is the portable grass cutter 500a. The motor unit 2 is attached to the portable grass cutter 500a via a connector 528. The portable grass cutter 500a comprises a grass cutter body 502 and a backpack 504. The grass cutter body 502 comprises a connection unit 506, a flexible shaft 508, a pole 510, an operation unit 512, and a blade 514. The connection unit 506 comprises a drum (not illustrated) connected to the third rotation output assembly 196 (see FIG. 20) and a drum housing 518 for housing the drum. The drum housing 518 is fastened to the front attachment surface 182 of the motor unit 2 with four screws (not illustrated) corresponding to the four threaded holes 182a (see FIG. 20) of the motor unit 2. The flexible shaft 508 extends between the connection unit 506 and the operation unit 512. The pole 510 extends between the operation unit 512 and the blade 514. When the electric motor 134 (see FIG. 15) of the motor unit 2 is driven, the driving power of the electric motor 134 is transmitted to the drum via the third rotation output assembly 196 and the drum is thereby rotated. The rotation of the drum is transmitted to the blade 514 via the flexible shaft 508 and a transmission shaft (not illustrated) housed in the pole 510. The portable grass cutter 500a can cut grass and trees by the rotating blade 514. The operation unit 512 comprises the grip 520 configured to be gripped by the user and a second lever 342 configured to be operable with finger(s) of the hand gripping the grip 520. As described above, the motor unit 2 attached to the portable grass cutter 500a comprises the second input assembly 312 (see FIGS. 25, 26, and 27). The second lever 342 is connected to the base end of the wire 322 of the second input assembly 312. The user can adjust the output of the electric motor 134 by pulling the wire 322 via the second lever 342. The backpack 504 comprises shoulder straps 522 configured to be worn on user’s shoulders, a back plate 524 along the user’s back, and a frame 526 fixed to the back plate 524. The frame 526 supports the motor unit 2 via the connector 528 attached to the motor unit 2.

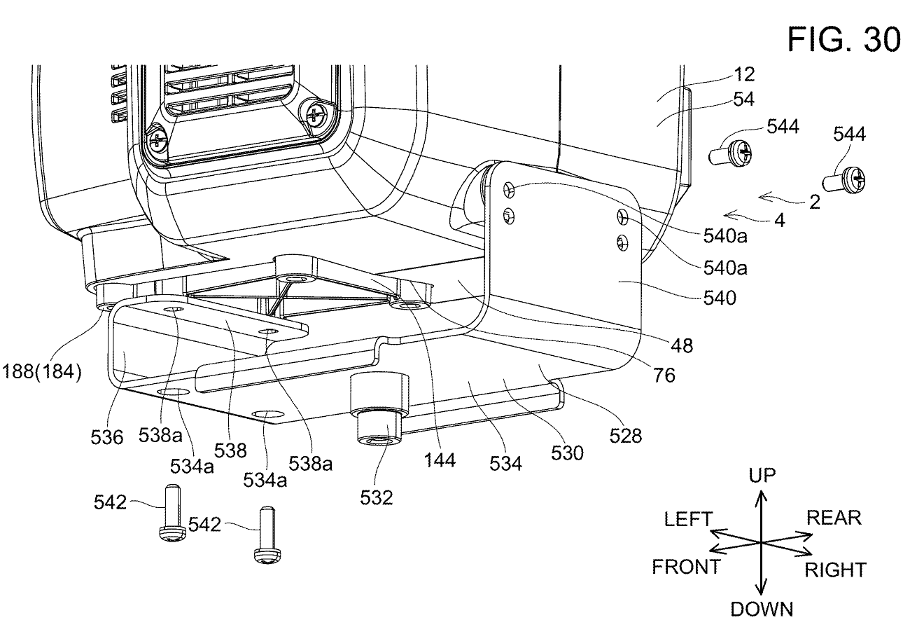

As illustrated in FIG. 30, the connector 528 comprises a plate member 530 fixed to the motor unit 2 and a rotation pin 532 rotatably attached to the plate member 530. The plate member 530 comprises a bottom plate portion 534 extending in the front-rear direction and the left-right direction, a front plate portion 536 extending upward from the front end of the bottom plate portion 534, an upper plate portion 538 extending rearward from the upper end of the front plate portion 536, and a rear plate portion 540 extending upward from the rear end of the bottom plate portion 534. The rotation pin 532 is located in a central portion of the bottom plate portion 534. The upper plate portion 538 is in contact with the lower attachment surfaces 188 of the mount base 144. Two insertion holes 538a are formed in the upper plate portion 538 to face the two compatible holes 364 (see FIG. 29) of the lower attachment surfaces 188. The upper plate portion 538 is fixed to the lower attachment surfaces 188 by inserting two screws 542 into the two insertion holes 538a and screwing them into the two compatible holes 364. Two through holes 534a are formed in the bottom plate portion 534, and the through holes 534a are configured to allow a screwdriver (not illustrated) used to screw the two screws 542 to pass therethrough. The rear plate portion 540 is in contact with the lower rear wall 54 of the outer housing 12. Two insertion holes 540a are formed in the rear plate portion 540 to face the two threaded holes 54a (see FIG. 9) formed in the lower rear wall 54. The rear plate portion 540 is fixed to the rear surface of the outer housing 12 by inserting two screws 544 into the two insertion holes 540a and screwing them into the two threaded holes 54a. The rotation pin 532 is fixed to the frame 526 of the backpack 504 (see FIG. 1). Thus, the motor unit 2 is rotatably attached to the backpack 504 via the connector 528.

As illustrated in FIGS. 2 and 3, the motor unit 2 can also be attached to the working unit 500 via the two front accessory holes 366 (see FIG. 29) and the two rear accessory holes 368 (see FIG. 29) in a different manner from GX35. In this case, the motor unit 2 is more firmly attached to the working unit 500 than when the motor unit 2 is attached to the working unit 500 via the two compatible holes 364 (i.e., when the motor unit 2 is attached to the working unit 500 in the same manner as GX35). This is because the motor unit 2 is fastened to the working unit 500 with more screws than the number of screws used to attach the motor unit 2 to the working unit 500 via the two compatible holes 364, and because the nominal diameter of screws used to fasten the motor unit 2 to the working unit 500 is greater than that used to attach the motor unit 2 to the working unit 500 via the two compatible holes 364.

In the example illustrated in FIG. 2, the working unit 500 is the plate compactor 500b. The plate compactor 500b comprises a pulley 546, a housing 548, a handle 550, and a compaction plate 552. The housing 548 comprises a belt cover 554 covering a belt (not illustrated) wound around the pulley 546 and a first mounting base 556 configured to contact the lower attachment surfaces 188 of the motor unit 2. The first mounting base 556 is fastened to the lower attachment surfaces 188 of the motor unit 2 with four screws (not illustrated) corresponding to the two front accessory holes 366 (see FIG. 29) and the two rear accessory holes 368 (see FIG. 29) of the motor unit 2. The pulley 546 is housed in the housing 548 and connected to the second rotation output assembly 194 (see FIG. 19) of the motor unit 2. When the electric motor 134 (see FIG. 15) of the motor unit 2 is driven, the driving power of the electric motor 134 is transmitted to the pulley 546 via the second rotation output assembly 194 and the pulley 546 is thereby rotated. When the pulley 546 is rotated, a vibration generator (e.g., eccentric weight) connected to the compaction plate 552 is thereby moved and the compaction plate 552 vibrates up and down. The plate compactor 500b can compact the ground by repeatedly pressing the vibrating compaction plate 552 against the ground. As described above, the motor unit 2 attached to the plate compactor 500b comprises the first input assembly 298. The user can adjust the output of the electric motor 134 by operating the first lever 306 of the first input assembly 298.

In the example illustrated in FIG. 3, the working unit 500 is the pressure washer 500c. The pressure washer 500c comprises a pump 558 connected to the second rotation output assembly 194 (see FIG. 19) of the motor unit 2 and a cart 560 on which the pump 558 and the motor unit 2 are mounted. The pump 558 comprises a second mounting base 562 configured to contact the front attachment surface 182 of the motor unit 2. The second mounting base 562 is fastened to the front attachment surface 182 of the motor unit 2 with four screws (not illustrated) corresponding to the four threaded holes 182a (see FIG. 19) of the motor unit 2. The cart 560 comprises a third mounting base 564 configured to contact the lower attachment surfaces 188 of the motor unit 2. The third mounting base 564 is fastened to the lower attachment surfaces 188 of the motor unit 2 with four screws (not illustrated) corresponding to the two front accessory holes 366 (see FIG. 29) and the two rear accessory holes 368 (see FIG. 29) of the motor unit 2. A water supply hose (not illustrated) connected to a water supply (e.g., public water supply) and a water discharge hose (not illustrated) including a jet nozzle at its distal end are connected to the pump 558. When the electric motor 134 (see FIG. 15) of the motor unit 2 is driven, the pump 558 is thereby actuated and water supplied through the water supply hose is pumped toward the water discharge hose. As a result, the water is jetted out from the jet nozzle. The pressure washer 500c can wash a target object (e.g., a car) with water jetted out from the jet nozzle. The pump 558 also comprises the water pressure sensor 566 configured to detect water pressure within the pump 558 or the water discharge hose. As described above, the motor unit 2 attached to the pressure washer 500c comprises the third input assembly 350. The water pressure sensor 566 is electrically connected to the control circuit board 154 (see FIG. 15) of the motor unit 2 via the communication cable 356 of the third input assembly 350. The control circuit board 154 automatically controls the output of the electric motor 134 based on the water pressure detected by the water pressure sensor 566.

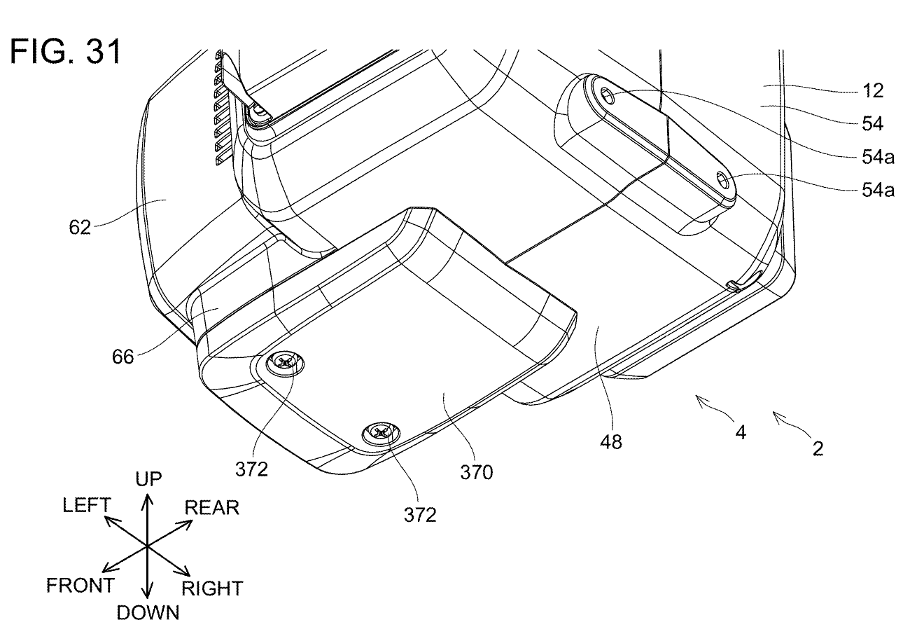

As illustrated in FIG. 31, the motor unit 2 further comprises a bottom cover 370 covering the lower exposure opening 76 (see FIG. 9) and the lower attachment surfaces 188 (see FIG. 9). The bottom cover 370 is attached to the mount base 144 with two screws 372 corresponding to the two compatible holes 364 (see FIG. 29). When the lower attachment surfaces 188 are not used to attach the motor unit 2 to a working unit 500, the bottom cover 370 is attached to the mount base 144 so that the lower exposure opening 76 and the lower attachment surfaces 188 are covered by the bottom cover 370. This prevents entry of foreign matter such as dust into the outer housing 12 through the lower exposure opening 76 and further prevents entry of foreign matter such as dust into the two compatible holes 364, the two front accessory holes 366, and the two rear accessory holes 368 (see FIG. 29) formed in the lower attachment surfaces 188.

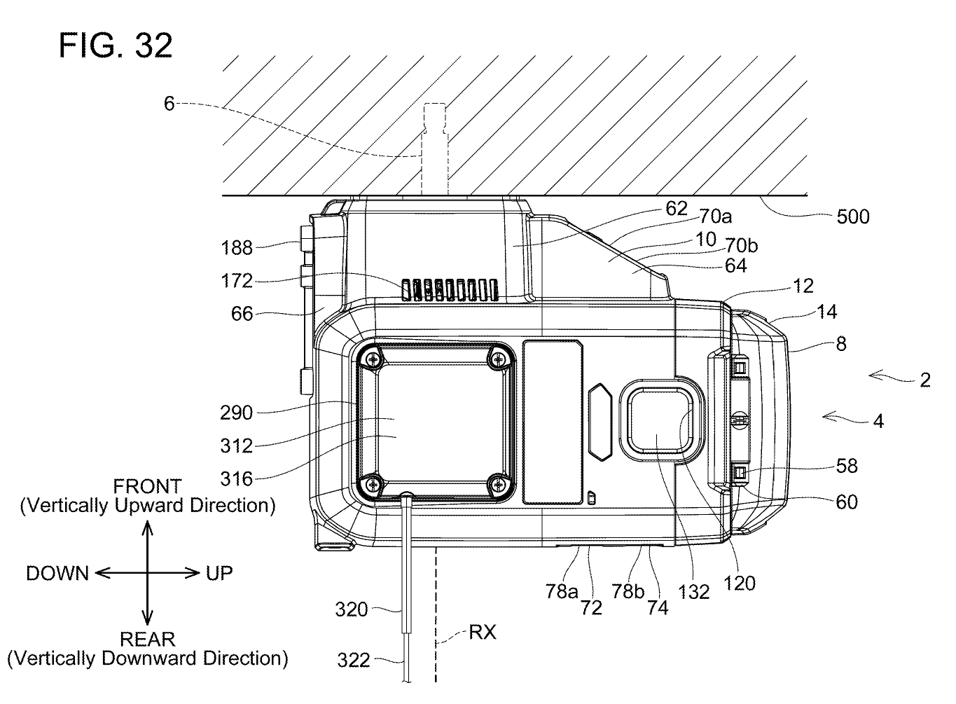

As illustrated in FIG. 32, the motor unit 2 can be attached in an upward orientation to a working unit 500 assuming a default usage orientation. The default usage orientation herein means the orientation of the working unit 500 when the user uses the working unit 500. The default usage orientation may be the orientation of the working unit 500 when the working unit 500 is on a surface such as the ground or the orientation of the working unit 500 while the user is carrying the working unit 500. Further, the upward orientation herein means the orientation of the motor unit 2 when the direction from the motor unit 2 toward the working unit 500 along the rotation axis RX of the rotation output assembly 6 (i.e., the front direction of the motor unit 2) is vertically upward.

As illustrated in FIG. 32, when the motor unit 2 is in the upward orientation, the sliding direction of the battery pack BP (or the power adapter 94) relative to the battery receptacle 16 (see FIG. 12) (i.e., the left direction of the motor unit 2) is along a horizontal plane and the shaft 58 defining the pivot axis of the battery cover 14 is along the vertical direction. Thus, the opening/closing direction of the battery cover 14 is along the horizontal plane. Further, when the motor unit 2 is in the upward orientation, the longitudinal direction of the motor unit body 4 (i.e., the up-down direction of the motor unit 2) is along the horizontal plane. The dimension of the motor unit body 4 in the vertical direction (i.e., the dimension of the motor unit body 4 in the front-rear direction) is 200 mm or less.

In the example illustrated in FIG. 32, the power button 72 and the display 74 are arranged in the rear arrangement openings 78a, 78b of the outer housing 12. Thus, the power button 72 and the display 74 are arranged in the surface of the motor unit 2 that is oriented vertically downward. Therefore, the power button 72 and the display 74 are positioned to be easily accessible by the user present vertically beneath the motor unit 2. Further, in the example illustrated in FIG. 32, the second input assembly 312 is attached to the left assembly receptacle 290. The second input assembly 312 is attached to the left assembly receptacle 290 in the orientation where the pipe 320 and the wire 322 extend vertically downward from the second assembly cover 316. Therefore, the user present vertically beneath the motor unit 2 can easily pull the wire 322.

The motor unit 2 can be attached in various orientations (not limited to the upward orientation) to a working unit 500 assuming the default usage orientation. In other words, the motor unit 2 can be attached to a working unit 500 regardless of the angle (within 360 degrees) between the front direction of the motor unit 2 and the vertically upward direction.

### Modification

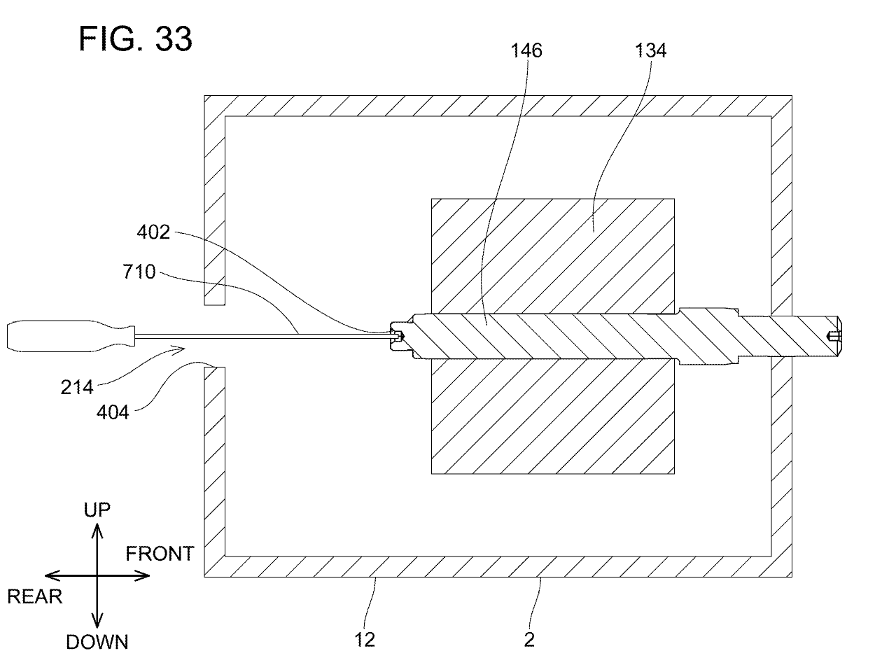

As illustrated in FIG. 33, a slot 402 configured to engage the tip end of a flathead screwdriver 710 may be formed in the rear end of the motor shaft 146. Further, a tool opening 404 configured to allow the flathead screwdriver 710 to pass therethrough in the front-rear direction may be formed in the rear wall of the outer housing 12. The user may lock the rotation of the motor shaft 146 by inserting the flathead screwdriver 710 into the tool opening 404 and engaging the tip end of the flathead screwdriver 710 with the slot 402. Thus, the tool opening 404 and the slot 402 may function as the shaft lock mechanism 214. Components located rearward of the motor shaft 146 (e.g., the control unit 140 illustrated in FIG. 15) may be relocated to other positions in order to engage the flathead screwdriver 710 with the slot 402.

(See FIGS. 4 and 5.) The motor unit 2 may comprise additional button(s) in the front arrangement openings 70a, 70b (or the rear arrangement openings 78a, 78b). For example, the motor unit 2 may comprise a switching button for switching the rotation direction of the motor shaft 146 (see FIG. 15).

(See FIGS. 18, 19 and 20.) There need not always be multiple types of rotation output assemblies 6, and there may be only one type of rotation output assembly.

(See FIG. 21.) The shaft lock mechanism 214 may be configured to lock the rotation of the motor shaft 146 without using a tool such as the spanner 700. For example, the shaft lock mechanism 214 may comprise a lock member movably supported on the outer housing 12 and the lock member may engage the two flat surfaces 204 of the motor shaft 146, thereby locking the rotation of the motor shaft 146.

(See FIG. 21.) The two flat surfaces 204 may be formed on a component (e.g., the centrifugal fan 136) other than the motor shaft 146. If the motor unit 2 comprises a speed reducer such as a bevel gear, the two flat surfaces 204 may be formed on the speed reducer.

(See FIG. 21.) Instead of the two flat surfaces 204, another type of engagement element may be used. For example, a hole configured to engage a pin may be used as an engagement element. The rotation of the motor shaft 146 may be locked by engaging a pin with the hole.

(See FIG. 4.) The lid 216 of the motor unit 2 may not be detachable. Instead, the tool opening 208 may be irreversibly closed by welding the lid 216 thereto after the motor unit 2 has been assembled. The tool opening 208 may be formed in a portion other than the right wall of the projecting portion 62 of the outer housing 12. For example, the tool opening 208 may be formed in the connection between the right wall and the upper wall of the projecting portion 62. The insertion/removal direction of the spanner 700 into/from the tool opening 208 may be a direction other than the left-right direction. For example, the insertion/removal direction of the spanner 700 into/from the tool opening 208 may be the up-down direction, the front-rear direction, a direction from the upper right to the lower left, or a direction from the lower left to the upper right.

(See FIG. 15.) The first spindle 200 may be fixed to the motor shaft 146 in a different way than screwing the external thread 146a and the internal thread 200a together. For example, a key may be formed on the motor shaft 146, a key groove configured to engage the key may be formed in the first spindle 200, and the first spindle 200 may be fixed to the motor shaft 146 by engaging the key with the key groove. The same applies to the fixation of the second spindle 222 to the motor shaft 146 and the fixation of the drive member 228 to the motor shaft 146. In another example, the first spindle 200 (or the second spindle 222, the drive member 228) may be fixed to a speed reducer (e.g., a planetary gear mechanism) connected to the motor shaft 146.

(See FIGS. 12 and 13.) The through hole 120 may be formed in another wall other than the upper left wall 44 of the outer housing 12. For example, the through hole 120 may be formed in the upper rear wall 46 of the outer housing 12. In this example, the direction in which the power cable 110 and the power connector 112 pass through the through hole 120 may be parallel to the rotation axis RX. In another example, the through hole 120 may be formed in the battery cover 14.

(See FIG. 13.) The motor unit 2 may not comprise at least one of the first sealing member 122 and the second sealing member 132 (see FIG. 32). For example, the motor unit 2 may not comprise the first sealing member 122. In this example, the second sealing member 132 may usually be attached to the through hole 120. When the power adapter 94 is attached to the battery receptacle 16, the second sealing member 132 may be detached from the through hole 120 in order to pass the power cable 110 through the through hole 120. Thus, the through hole 120 may not be sealed when the power cable 110 extends therethrough. In another example, the motor unit 2 may not comprise the second sealing member 132. In this example, the first sealing member 122 may usually be attached to the through hole 120. The through hole 120 may be sealed only when the power adapter 94 is attached to the battery receptacle 16, by the power cable 110 extending through the fitting hole 126 of the first sealing member 122.

(See FIGS. 4 and 5.) The battery cover 14 may slide relative to the outer housing 12 to open and close, instead of pivoting relative to the outer housing 12 to open and close. In another example, the battery cover 14 may be detachably attached to the outer housing 12. In another example, the motor unit 2 may not comprise the battery cover 14.

(See FIGS. 4 and 9.) The motor unit 2 may not comprise one of the front attachment surface 182 and the lower attachment surfaces 188.

(See FIGS. 22 and 23.) There need not always be multiple types of cover assemblies, and there may be one type of cover assembly.

(See FIGS. 24, 25 and 28.) The first input assembly 298 (or the second input assembly 312, the third input assembly 350) may input information other than the information used to control the output of the electric motor 134 to the control circuit board 154. The first input assembly 298 (or the second input assembly 312, the third input assembly 350) may input information used to enable or disable a predetermined function (e.g., soft no-load function) of the motor unit 2 to the control circuit board 154. The soft no-load function herein means a function of automatically reducing the output of the electric motor 134 when the load on the electric motor 134 is low even while the electric motor 134 is being driven (e.g., when an operation by a working unit 500 is suspended). When the soft no-load function is enabled, the motor shaft 146 is prevented from rotating at a high speed more than necessary, thereby reducing noises and vibrations generated by the working unit 500.

(See FIGS. 24, 25, and 28.) There need not always be multiple types of input assemblies, and there may be only one type of input assembly.

(See FIGS. 22 and 24.) The input assemblies may be configured to be attached only to the right assembly receptacle 246. In another example, the input assemblies may be configured to be attached only to the left assembly receptacle 290. That is, the positions may not be interchangeable between the cover assemblies and the input assemblies.

(See FIGS. 22 and 24.) The cover assemblies (and the input assemblies) may be configured to be attached to the right assembly receptacle 246 only in one orientation. Similarly, the cover assemblies (and the input assemblies) may be configured to be attached to the left assembly receptacle 290 only in one orientation.

(See FIG. 29.) The two front accessory holes 366 and the two rear accessory holes 368 may be located frontward of the first virtual plane P1. The distance between the second virtual plane P2 and the fourth virtual plane P4 may be less than the distance between the second virtual plane P2 and the third virtual plane P3. The center-to-center distance between the two front accessory holes 366 may be less than the center-to-center distance between the two compatible holes 364 (i.e., 50 mm). The center-to-center distance between the two rear accessory holes 368 may be less than the center-to-center distance between the two compatible holes 364 (i.e., 50 mm). The center-to-center distance between the two front accessory holes 366 may not be the same as the center-to-center distance between the two rear accessory holes 368.

(See FIG. 32.) When the motor unit 2 is in the upward orientation, the sliding direction of the battery pack BP (and the power adapter 94) relative to the battery receptacle 16 may not be along the horizontal plane. For example, when the motor unit 2 is in the upward orientation, the sliding direction of the battery pack BP (and the power adapter 94) relative to the battery receptacle 16 may be the vertically upward direction. When the motor unit 2 is in the upward orientation, the opening/closing direction of the battery cover 14 may not be along the horizontal plane. For example, when the motor unit 2 is in the upward orientation, the opening/closing direction of the battery cover 14 may be along a plane parallel to the vertical direction. When the motor unit 2 is in the upward orientation, the longitudinal direction of the motor unit body 4 may not be along the horizontal plane. For example, when the motor unit 2 is in the upward orientation, the longitudinal direction of the motor unit body 4 may be the vertical direction. When the motor unit 2 is in the upward orientation, the dimension of the motor unit body 4 in the vertical direction (i.e., the dimension of the motor unit body 4 in the front-rear direction) may be greater than 200 mm.

(See FIG. 32.) The discharge openings 172 may be formed in another portion other than the neck portion 10. For example, the discharge openings 172 may be formed in the head portion 8 (i.e., the second portion 38 of the outer housing 12).

### Features of Embodiment

In one or more embodiments, the motor unit 2 is configured to be detachably attached to a working unit 500 to drive the working unit 500. The motor unit 2 comprises: the motor unit body 4 including the electric motor 134 and the outer housing 12 (an example of housing) that supports the electric motor 134; and the rotation output assembly 6 exposed to the outside of the motor unit body 4 and configured to rotate to output driving power of the electric motor 134 to the working unit 500. When the working unit 500 is in the default usage orientation, the motor unit 2 attached to the working unit 500 is in the upward orientation in which the direction from the motor unit 2 toward the working unit 500 along the rotation axis RX of the rotation output assembly 6 is vertically upward.

There have not been any conventional motor units that can be attached in the upward orientation to a working unit in its default usage orientation. However, the configuration above allows the motor unit 2 to be attached in the upward orientation to the working unit 500 in the default usage orientation. Thus, the configuration above allows a user to attach the motor unit 2 to a working unit 500 located above the user’s head from vertically below, i.e., to a position easily accessible by the user. Therefore, the configuration above allows the motor unit 2 to be attached in a user-friendly orientation to the working unit 500.

In one or more embodiments, the motor unit 2 further comprises the battery receptacle 16 disposed on the outer housing 12 and to which the battery pack BP is detachably attached to supply electric power to the electric motor 134. The battery pack BP is configured to be attached to the battery receptacle 16 by being slid leftward (an example of a predetermined first direction) relative to the battery receptacle 16. When the motor unit 2 is in the upward orientation, the left direction is along the horizontal plane.

If the working unit 500 is located in the sliding direction of the battery pack BP, the battery pack BP (or the user’s hand on the battery pack BP) may contact the working unit 500 when it is slid in the sliding direction. This may make the attachment/detachment of the battery pack BP to/from the battery receptacle cumbersome. When the motor unit 2 is in the upward orientation, the working unit 500 is expected to be located vertically above the motor unit 2. According to the configuration above, the direction in which the battery pack BP is slid relative to the battery receptacle 16 is along the horizontal plane (i.e., a direction in which the working unit 500 is not expected to be located). Therefore, the battery pack BP (or the user’s hand on the battery pack BP) is prevented from contacting the working unit 500 when the battery pack BP is slid. Thus, the cumbersome nature of attachment/detachment of the battery pack BP to/from the battery receptacle 16 can be reduced.

In one or more embodiments, the motor unit 2 further comprises the battery cover 14 pivotably attached to the outer housing 12 between the closing position in which the battery cover 14 covers the battery pack BP attached to the battery receptacle 16 and the open position in which the battery cover 14 does not cover the battery pack BP attached to the battery receptacle 16. When the motor unit 2 is in the upward orientation, the battery cover 14 moves between the closing position and the open position along the horizontal plane.

If the working unit 500 is located in the opening/closing direction of the battery cover 14, the battery cover 14 (or the user’s hand on the battery cover 14) may contact the working unit 500 when the battery cover 14 is opened/closed. This may make the opening/closing of the battery cover 14 cumbersome. When the motor unit 2 is in the upward orientation, the working unit 500 is expected to be located vertically above the motor unit 2. According to the configuration above, the opening/closing direction of the battery cover 14 is along the horizontal plane (i.e., a direction in which the working unit 500 is not expected to be located). Therefore, the battery cover 14 (or the user’s hand on the battery cover 14) is prevented from contacting the working unit 500 when the battery cover 14 is opened/closed. Thus, the cumbersome nature of opening/closing of the battery cover 14 can be reduced.

In one or more embodiments, when the motor unit 2 is in the upward orientation, the longitudinal direction of the motor unit body 4 (i.e., the front-rear direction of the motor unit 2) is along the horizontal plane.

The motor unit 2 in the upward orientation may be attached to the working unit 500 from vertically below. In this case, if the vertical dimension of the motor unit body 4 is large, the motor unit 2 may contact an object located vertically below the working unit 500 (e.g., the user’s body, the ground, etc.). With the configuration above, when the motor unit 2 in the upward orientation is attached to the working unit 500 from vertically below, the vertical dimension of the motor unit body 4 is relatively small. Therefore, the motor unit 2 is prevented from contacting an object located vertically below the working unit 500.

In one or more embodiments, when the motor unit 2 is in the upward orientation, the vertical dimension of the motor unit body 4 is 200 mm or less.

The motor unit 2 in the upward orientation may be attached to the working unit 500 from vertically below. In this case, if the vertical dimension of the motor unit body 4 is large, the motor unit 2 may contact an object located vertically below the working unit 500 (e.g., the user’s body, the ground, etc.). With the configuration above, when the motor unit 2 in the upward orientation is attached to the working unit 500 from vertically below, the vertical dimension of the motor unit body 4 is relatively small. Therefore, the motor unit 2 is prevented from contacting an object located vertically below the working unit 500.

In one or more embodiments, the motor unit 2 further comprises the power button 72 for turning on and off the main power of the motor unit 2. When the motor unit 2 is in the upward orientation, the power button 72 is disposed on a surface of the motor unit 2 that is oriented vertically downward.

With the configuration above, when the motor unit 2 is attached in the upward orientation to the working unit 500 from vertically below, the power button 72 is located on a surface of the motor unit 2 that is away from the working unit 500, i.e., a surface of the motor unit 2 that is easily accessible by the user. This further improves user-friendliness of the motor unit 2.

In one or more embodiments, the motor unit body 4 comprises: the neck portion 10 extending vertically downward from the working unit 500 when the motor unit 2 is in the upward orientation; and the head portion 8 connected to the vertically lower end of the neck portion 10, wherein a dimension of the head portion 8 in a horizontal direction is larger than that of the neck portion 10.

With the configuration above, the user can hold the motor unit body 4 by grabbing the head portion 8. Further, with the configuration above, when the motor unit 2 is attached to the working unit 500, the neck portion 10 is located between the head portion 8 and the working unit 500, thus the head portion 8 is located apart from the working unit 500. This prevents the user’s hand on the head portion 8 from contacting the working unit 500, thereby freeing the user from cumbersome work.

In one or more embodiments, the motor unit 2 further comprises the discharge openings 172 (an example of ventilation opening) that provides communication between the inside and the outside of the outer housing 12. The discharge openings 172 are formed in the neck portion 10.

Generally, the neck portion 10 is expected to be less accessible by the user than the head portion 8. According to the configuration above, the discharge openings 172 are formed in the portion less accessible by the user. Therefore, air intake and/or air discharge through the discharge openings 172 is not hindered by the user.

In one or more embodiments, the motor unit 2 is configured to be detachably attached to a working unit 500 to drive the working unit 500. The motor unit 2 comprises: the motor unit body 4 including the electric motor 134 and the outer housing 12 that supports the electric motor 134; and the rotation output assembly 6 exposed to the outside of the motor unit body 4 and configured to rotate to output driving power of the electric motor 134 to the working unit 500. The motor unit 2 is configured to be attached to the working unit 500 in the default usage orientation, regardless of the direction from the motor unit 2 toward the working unit 500 along the rotation axis RX of the rotation output assembly 6.

With the configuration above, there are no restrictions on the orientation of the motor unit 2 when it is attached to the working unit 500 in the default usage orientation. Therefore, the configuration above allows the motor unit 2 to be attached in a user-friendly orientation (e.g., in a user-accessible orientation) to the working unit 500.

In one or more embodiments, an electric working machine comprises: a working unit 500; and the motor unit 2 configured to be detachably attached to the working unit 500 to drive the working unit 500. The motor unit 2 comprises: the motor unit body 4 including the electric motor 134 and the outer housing 12 that supports the electric motor 134; and the rotation output assembly 6 exposed to the outside of the motor unit body 4 and configured to rotate to output driving power of the electric motor 134 to the working unit 500. When the working unit 500 is in the default usage orientation, the motor unit 2 attached to the working unit 500 is in the upward orientation in which the direction from the motor unit 2 toward the working unit 500 along the rotation axis RX of the rotation output assembly 6 is vertically upward.

There have not been any conventional motor units that can be attached in the upward orientation to a working unit in its default usage orientation. However, the configuration above allows the motor unit 2 to be attached in the upward orientation to the working unit 500 in the default usage orientation. Thus, the configuration above allows the user to attach the motor unit 2 to the working unit 500 located above the user’s head from vertically below, i.e., to a position easily accessible by the user. Therefore, the configuration above allows the motor unit 2 to be attached in a user-friendly orientation to the working unit 500.

What is claimed is:

1. A motor unit configured to be detachably attached to a working unit to drive the working unit, the motor unit comprising:
a motor unit body including an electric motor and a housing that supports the electric motor; and
a rotation output assembly exposed to outside of the motor unit body and configured to rotate to output power of the electric motor to the working unit,
wherein
when the working unit is in a default usage orientation, the motor unit attached to the working unit is in an upward orientation in which a direction from the motor unit toward the working unit along a rotation axis of the rotation output assembly is vertically upward.

2. The motor unit according to claim 1, further comprising a battery receptacle disposed on the housing and to which a battery pack is detachably attached,
wherein
the battery pack is configured to be attached to the battery receptacle by being slid in a predetermined first direction relative to the battery receptacle, and
when the motor unit is in the upward orientation, the first direction is along a horizontal plane.

3. The motor unit according to claim 2, further comprising a battery cover pivotably attached to the housing between a closing position in which the battery cover covers the battery pack attached to the battery receptacle and an open position in which the battery cover does not cover the battery pack attached to the battery receptacle,
wherein when the motor unit is in the upward orientation, the battery cover moves between the closing position and the open position along the horizontal plane.

4. The motor unit according to claim 1, wherein when the motor unit is in the upward orientation, a longitudinal direction of the motor unit body is along a horizontal plane.

5. The motor unit according to claim 1, wherein when the motor unit is in the upward orientation, a vertical dimension of the motor unit body is 200 mm or less.

6. The motor unit according to claim 1, further comprising a power button for turning on and off a main power of the motor unit,
wherein when the motor unit is in the upward orientation, the power button is disposed on a surface of the motor unit that is oriented vertically downward.

7. The motor unit according to claim 1, wherein the motor unit body comprises:
a neck portion extending vertically downward from the working unit when the motor unit is in the upward orientation; and
a head portion connected to a vertically lower end of the neck portion, wherein a dimension of the head portion in a horizontal direction is larger than that of the neck portion in the horizontal direction.

8. The motor unit according to claim 7, further comprising a ventilation opening that provides communication between an inside and an outside of the housing,
wherein the ventilation opening is formed in the neck portion.

9. A motor unit configured to be detachably attached to a working unit to drive the working unit, the motor unit comprising:
a motor unit body including an electric motor and a housing that supports the electric motor; and
a rotation output assembly exposed to outside of the motor unit body and configured to rotate to output power of the electric motor to the working unit,
wherein
the motor unit is configured to be attached to the working unit in a default usage orientation, regardless of a direction from the motor unit toward the working unit along a rotation axis of the rotation output assembly.

10. An electric working machine comprising:
a working unit; and
a motor unit configured to be detachably attached to the working unit to drive the working unit,
wherein the motor unit comprises:
a motor unit body including an electric motor and a housing that supports the electric motor; and
a rotation output assembly exposed to outside of the motor unit body and configured to rotate to output power of the electric motor to the working unit,
wherein
when the working unit is in a default usage orientation, the motor unit attached to the working unit is in an upward orientation in which a direction from the motor unit toward the working unit along a rotation axis of the rotation output assembly is vertically upward.

11. The motor unit according to claim 3, wherein when the motor unit is in the upward orientation, a longitudinal direction of the motor unit body is along the horizontal plane,
when the motor unit is in the upward orientation, a vertical dimension of the motor unit body is 200 mm or less,
the motor unit further comprises a power button for turning on and off a main power of the motor unit,
when the motor unit is in the upward orientation, the power button is disposed on a surface of the motor unit that is oriented vertically downward,
the motor unit body comprises:
a neck portion extending vertically downward from the working unit when the motor unit is in the upward orientation; and
a head portion connected to a vertically lower end of the neck portion, wherein a dimension of the head portion in a horizontal direction is larger than that of the neck portion in the horizontal direction,
the motor unit further comprises a ventilation opening that provides communication between an inside and an outside of the housing, and
the ventilation opening is formed in the neck portion.
